(19) United States
(12) Patent Application Publication
(10) Pub. No.: US 2016/0335446 A9
(43) Pub. Date: Nov. 17, 2016

(54) Detection of Obscured Copying Using Discovered Translation Files and Other Operation Data

(71) Applicants: Kendyl A. Román, Sunnyvale, CA (US); Paul Raposo, Oakland, CA (US)

(72) Inventors: Kendyl A. Román, Sunnyvale, CA (US); Paul Raposo, Oakland, CA (US)

(21) Appl. No.: 12/825,662

(22) Filed: Jun. 29, 2010

Related U.S. Application Data
(63) Continuation-in-part of application No. 11/299,529, filed on Dec. 12, 2005, now abandoned.
(60) Provisional application No. 60/635,908, filed on Dec. 10, 2004.
(60) Provisional application No. 60/635,562, filed on Dec. 13, 2004.

(51) Int. Cl. G06F 17/30

(52) U.S. Cl. CPC G06F 21/6218

(57) ABSTRACT

Systems and methods that automatically compare sets of files to determine what has been copied even when sophisticated techniques for hiding or obscuring the copying have been employed. The file compare system comprises a file compare program that uses various operational data and user interface options to detect illicit copying, highlight and align matching lines, and to produced a formatted report. A discovered translations file is used to match translated tokens. Other operation data files specify rules that the file program then uses to improve its results. The generated report contains statistics and full disclosures of the discovered translations used and the other methods used in creating the exhibits. The system includes a bulk compare program that automatically detects likely file pairings and candidates for validation as suspected translations, which can be used on iterative runs. The user is given full control in the final output and the system automatically reforms the reports and recalculations the statistics for consistent and accurate final presentation.

### RELATED APPLICATIONS

This application claims priority of U.S. provisional application Ser. No. 60/635,908, filed Dec. 10, 2004, entitled “DETECTION OF OBSCURED COPYING USING KNOWN TRANSLATIONS FILES AND OTHER OPERATIONAL DATA”, which is hereby incorporated by reference, and U.S. provisional application Ser. No. 60/635,562, filed Dec. 13, 2004, entitled “DETECTION OF OBSCURED COPYING USING KNOWN TRANSLATIONS FILES AND OTHER OPERATIONAL DATA”, which is hereby incorporated by reference.

This application also claims priority of U.S. application Ser. No. 11/299,529, filed Dec. 12, 2005, entitled “DETECTION OF OBSCURED COPYING USING KNOWN TRANSLATION FILES AND OTHER OPERATIONAL DATA,” which is expressly incorporated herein by reference.

### BACKGROUND

### Field of the Invention

This invention relates to systems and methods for comparing files to detect the use of copied information, and more particularly to such systems and methods that detect copying where the copying has been obscured by various techniques.

### The Problem

We are in the midst of the Information Age. More and more people make their living as information workers. The technologies fueling the Information Age are still being developed at an intense rate. For example, during the last few decades there has been unprecedented development and growth in the use of the Internet. The Internet information space known as the World Wide Web has become a significant tool for communications, commerce, research, and education. Almost all of this information is stored electronically in computer files, which can be easily copied, transferred anywhere in the world, and modified. At the same time, many have made extreme efforts to share in the fortunes to be made in this new era of computer based information and communication. Some of this has been evidenced by the “irrational exuberance” of the Internet boom.

Unfortunately, the ease of access to information and the ease at which information can be copied and modified, combined with both personal and corporate greed, has led to what appears to be unprecedented levels of illegal copying of copyrighted materials, including the computer programs that run on the computers of the information age and the information found on the World Wide Web. This illegal copying has led to numerous lawsuits claiming Federal copyright infringement and both Federal and state trade secret misappropriation. Significant trade secret theft can also lead to criminal prosecution.

At the same time, computer equipment has become more powerful and increased in storage capacity—both primary memory (RAM) and secondary storage (disk and tape drives). Computer programs, likewise, have grown in size and complexity. Some software projects are comprised of tens of thousands of source code files, collectively containing millions of lines of code. The source version control systems for those projects may contain billions of lines of code. The version control systems may also include other types of media including design documents, database schemas, graphics files, and other data, all subject to copyright and trade secret protection.

The courts are interested in the literal copying and use of the literal lines of code that make up these computer programs. Copyright extends to translations of the original work as well. Trade secrets can be copied without copying the literal lines of code. Literal copying and literal translation are direct evidence of copying. The courts have also said, “Where there is no direct evidence of copying, a plaintiff may establish an inference of copying by showing (1) access to the allegedly-infringed work by the defendant(s) and (2) a substantial similarity between the two works at issue.” In determining substantial similarity, the first step is to filter out those elements that were not protectable, namely those which are not original to the copyright holder or which required minimal creativity.

Also, the courts have recognized that a significant portion of the work and creative effort of developing computer programs is found in tasks not limited to the actual writing of the lines of source code, but include many layers of abstract design. This work includes understanding customer and system requirements, designing external interfaces, designing internal interfaces, architecting the structure of the system and individual modules, developing abstract algorithms, coding, integration, testing, bug fixing, and maintenance. Because of this, the courts recognized copying of the non-literal aspects of the computer program as well.

Because of the highly technical nature of computer programming, the courts rely on technical experts to shed light on what was copied, whether the copying was allowable, and whether the copying was substantial. The courts have provided various guidelines for determining non-literal copying. One guideline is to analyze the sequence, structure, and organization of the computer program. More recently, the courts are adopting an “abstraction-filtration-comparison” test. In this test, first the computer program is broken down into layers of abstraction, second, the elements that are not protected are filtered out, and third, the remaining elements are compared against the alleged infringing work (at each of the levels of abstraction). The courts have been interested in the literal lines of code as well as more abstract aspects of the computer program, such as the algorithms, the parameter lists, modules or files that make up each program, the database architecture, and the system level architecture.

The similarities at each of these levels can be shown by creating side-by-side listings of the copied materials. The various aspects of the comparison can be indicated with various types of formatting.

In trade secret cases, information that was general knowledge (as opposed to specific knowledge) or which is readily ascertainable must also be filtered.

However, in order to prepare the side-by-side listings, the expert must first determine which pairs of files from the respective works to compare. Once a pair of files with some level of copying has been found, the literal and non-literal aspects of the copying must be indicated in some manner. This can be done manually using a word processor, such as Microsoft Word brand or FrameMaker brand word processors. However, when there are tens of thousands of files and millions of lines of code it becomes almost impossible for an expert or group of experts to accurately find all instances of copying and to properly apply the filtering and formatting required for presentation to the judge and jury. Further, to qualify as a technical expert, the individual must have recognized experience and expertise in the computer science, as well as the ability to present the information, testify, and overcome the challenges and rigors of the courtroom. Qualified individuals, who are at the peak of their careers and are in high demand, earn relatively high hourly compensation. A typical case may require hundreds or thousands of hours of analysis and exhibit preparation. The cost of doing the work manually can be prohibitive. Further, the volume of work can be difficult to perform error free. Any errors in the analysis or presentation can be used to challenge the reliability of the evidence and the credibility of the expert witness.

### PRIOR ART

Software developers are aware of a number of code comparison tools associated with their development environment. For example the UNIX brand development environment has long had a utility known as “diff” which compare lines of files for exact matching. The diff utility will produce output that indicates which block of lines are identical, which block of lines have been added, and which block of lines have been deleted. It is typical for an integrated development environment (IDE), such as Microsoft Developer Studio brand, Microsoft SourceSafe brand, Metrowerks CodeWarrior brand, or Apple Xcode brand IDEs, to include a file compare utility. There are also stand-alone programs such as WinDiff brand or Helios Software Solutions TextPad brand file compare programs. Many of these programs provide the same comparison features as the original Unix brand diff utility. Some of these show lines added, changed and deleted with colored highlighting. Some include a graphical user interface that aligns identically matching lines of code in a side-by-side format that can be scrolled in a window.

However all of these diff-like programs are limited in detecting illegal copying because they only report lines that match exactly. Small insignificant changes can easily be made to each copied line and these diff-like programs will report that no lines are identical, giving a false indication that there is no copying.

Editing programs, such as Microsoft Word and those found in the various IDEs, have a feature that allows all the occurrences of a certain word or phrase to be changed (or translated) to a different word or phrase. For example every occurrence of “dog” could be translated to “canine”. This is known as “Change All” or “global query/replace”. Software developers can easily generate a list of the important names (or identifiers) in a computer program. Software developers with nefarious intent can easily develop a list of substitute words for each of those identifiers, and change every important name wherever it occurs throughout a set of copied files. In a matter of minutes the computer can make millions of changes to tens of thousands of files. The program would still be structured and behave identically even though none of the important lines of code would match identically.

These diff-like programs cannot detect such global changes.

Further, the diff program algorithm is limited. It can get confused in its comparison. If a block of code is copied but moved out of order, the diff program may fail to detect the identical lines simply because they have been rearranged within the file.

A software developer with nefarious intent can easily defeat the illegal copying detection capabilities of programs such as diff.

### More Sophisticated Copying

A software developer who is attempting to copy a set of source code, and has some understanding that they cannot literally copy the source code without detection, can employ various techniques to avoid literal copying that can easily be detected, while still effectively copying the source code. To avoid being caught, an illicit copier can employ more sophisticated techniques to hide or obscure the evidence of their illegal copying.

As discussed above, the easiest approach is to simply use an editor to make global changes throughout the code to identifiers such as variable and method names. This makes it difficult for conventional comparison programs to detect the copying.

Another approach is to add spaces, tabs, carriage returns, words or comments that don't change the essential function of the code, but will defeat diff-like programs.

Another approach is to reorder the code so that the sections work the same but have been moved around to avoid side-by-side comparison.

Another approach is to re-write the same algorithms in a different language, for example, translating from C to Visual Basic, from C to C++, from Basic to C++, and so forth.

Another approach is to rewrite every line of code using different but equivalent programming constructs. This makes individual line-by-line comparison impossible because the equivalent elements may be split across non-contiguous lines.

### My Earlier Testing

I conceived of a basic technique to overcome and detect some of these techniques, such as the global change of important identifiers. I developed custom file compare test programs that read two files and broke the words and symbols of the files into individual elements called tokens. As I manually compared the files, I added special instructions and data into each different custom test program to reverse the global changes that had been made by the illicit copier. These programs also output a report where the two programs were presented side-by-side with line numbers. When these early test programs were successful in identifying translated lines of code, the lines were lined up (or aligned) side-by-side by inserting extra blank lines. Lines of code that have been literally copied or translated were shown in red and are underlined. The lines were numbered with the original line numbers. Lines that were too long were truncated (cut off) so that the lines would still match up.

While these situation specific test programs validated this basic approach, and saved a significant amount of time preparing exhibits that could be edited by hand for completeness, it was clear that I had not yet developed a complete solution that would meet the needs of general use over a wide range of situations.

One problem was that the translation rules and terms are built-in to each custom program. This required changes to the program each time a new rule or new matching pair of translation equivalents were found. The required repeated modification of the program resulted in multiple versions and constant changing of the program.

Another problem was that each project required its own custom program so that the program could never be finished. Another problem was maintaining a growing set of custom programs. It was difficult to fix software defects or to add general enhancements. A fix to one custom program might break another custom program that had a different set of features.

Further, testing with a broader range of test cases revealed that many techniques for hiding illicit copying were still not covered by these simple test programs. For example, a situation where the illicit copier added carriage returns, words or comments that didn't change the essential function of the code, still defeated my early test programs. Also, some programming environments include unique numbers on every line in a file. The simple act of copying the contents of a file into another file will cause every line to no longer match because of the unique numbers.

In some situations subsets of files, appearing in the same projects, were found to have been translated using different translations for the same words. My early test programs could not handle multiple translations of the same words.

Also, the process of finding pairs of files to be compared was still a time consuming manual process.

Further, once I produced a side-by-side listing with marking showing the lines that were copied, it was necessary to filter out, for example, lines that were in the public domain or which were generally known. In some cases, an employee of one of the parties may be the best domain expert to review what should be filtered versus what would be proprietary or trade secret information. However, often that person may be limited because of protective orders from seeing both sides of the comparison. There is a need to prepare marked up listings of either side of a side-by-side comparison, that is identical in markup and presentation to the side-by-side listings but which contains on the code from one of the parties.

### Solution Needed

What is needed is a comprehensive system that will automatically:
(a) find and mark literal copying
(b) find and mark literal translation
(c) filter material that should be filtered
(d) identify copied material that has been filtered
(e) calculate statistics on total lines, lines copied, lines obscured, lines filtered, and percentages
(f) identify translations that have been used
(g) identify copying even when the code was translated from one programming language to another
(h) identify copying even when words and comments have been changed without changing the essential function of the code
(i) provide a mechanism to identify copying even when the carriage returns were added
(j) provide a mechanism to exclude portions of each line prior to comparing the more meaning portions (e.g. exclude unique number of each line)
(k) determine which pairs of files should be compared
(l) skip pairs of files that have little or no similarity so that those that do have similarity can be presented sooner and with fewer resources
(m) identify possible translations that might not yet have become known (or discovered)
(n) apply customized rules based on observed technique for obscuring copying
(o) provide an easy to use method of customizing the rules and translation used for each project without modifying the program
(p) after producing a side-by-side listing marked to show copied, obscured, and filtered between two files, producing a identically marked listing of each of the two files separately.
Such a program would be able to be used “as is” on many projects without custom programming for each project, and thus would be much more easily maintained and enhanced, would have increased reliability, and could be used without internal programming knowledge or effort.

### SUMMARY OF THE INVENTION

Accordingly, it is an objective of the present invention to provide a comprehensive system that will automatically compare sets of files to determine what has been copied even when sophisticated techniques for hiding or obscuring the copying have been employed.

### Objects and Advantages

Accordingly, beside the objects and advantages described above, some additional objects and advantages of the present invention are:
1. To reduce the cost of analyzing files in a copyright or trade secret lawsuit.
2. To automatically find and mark literal copying.
3. To automatically find and mark literal translation.
4. To automatically filter material that should be filtered.
5. To automatically identify copied material that has been filtered.
6. To automatically calculate statistics on total lines, lines copied, lines obscured, lines filtered, and percentages.
7. To automatically identify translations which have been used.
8. To automatically identify copying even when the code was translated from one programming language to another.
9. To automatically identify copying even when words and comments have been changed without changing the essential function of the code.
10. To provide a mechanism to automatically identify copying even when the carriage returns were added.
11. To automatically identify copying even when sections of files have been rearranged (both within a file and between files).
12. To identify information that has been copied more than once.
13. To automatically provide a mechanism to exclude portions of each line prior to comparing the more meaningful portions (e.g. exclude unique number of each line).
14. To automatically determine which pairs of files should be compared.
15. To automatically skip pairs of files which have little or no similarity so that those that do have similarity can be presented sooner and with fewer resources.
16. To automatically identify and confirm possible translations that might not yet have become known (or discovered).
17. To automatically apply customized rules based on observed technique for obscuring copying.
18. To automatically provide an easy to use method of customizing the rules and translation used for each project without modifying the program.
19. To provide a method of dynamically loading a discovered translations table for each file comparison, which can be modified and stored separately for each group of appropriate files.
20. To provide a method of dynamically loading a suspected translations table for each file comparison, which can be modified and stored separately for each group of appropriate files, whereby suspected translations can be identified and verified for later inclusion as discovered translations for future runs.
21. To provide a method of detection similarities in comments which utilize different comment syntax.
22. To provide a threshold that limits usage of computer processing and storage resources on compares yield little or no similarity, by aborting or reducing processing and avoiding formatted report generation.
23. To provide output file names which are meaningful to facilitate rapid review of highly similar files.
24. To provide a system that will run on multiple computer platforms with different file naming conventions.
25. To provide a system that will determine file subsets for batch comparisons based on user selectable criteria.
26. To provide a system that will determine file subsets for batch comparisons based directory structure.
27. To provide for multiple translations of the same word in different file pairs.
28. To provide a system that efficiently processes batch comparisons by reusing information previously obtained for one or both files in the pair.
29. To increase the accuracy of the reports.
30. To provide a common look for multiple forensic exhibits.
31. To provide forensic exhibits that can be read on a wide variety of platforms and by a wide variety of users.
32. To provide user selectable output sizes (e.g. letter and legal sized paper) and layouts (e.g. portrait or landscape) with maximum use of page space while maintaining readability.
33. To provide full disclosure of specialized rules, forensic methods, and evidence modifications.
34. To provide full data for each line, without truncation, while still maintaining proper alignment of matching lines.
35. To provide a way to identify meaningful tokens from different programming language using language specific control and data.
36. To apply language specific options based on automatic language detection.
37. To provide a report of translations detected that have language keywords and other non-illicit language filtered.
38. After producing a side-by-side listing marked to show copied, obscured, and filtered between two files, to provide an identically marked, separate listing of each of the two files.

### DRAWING FIGURES

In the drawings, closely related figures have the same number but different alphabetic suffixes.

FIG. 1 illustrates the basic components of the system.

FIGS. 2A and 2B shows example files.

FIG. 2C shows an example of discovered translation data.

FIG. 2D shows an example two page exhibit identifying literal copying and literal translation.

FIGS. 3A through 3D show flow charts for the file compare operation.

FIG. 4 shows an advanced alternate system.

FIGS. 5A and 5B shows alternate example files.

FIG. 5C shows another example of discovered translation data.

FIG. 5D shows an example of suspected translation data.

FIG. 5E shows an example of exclusion data.

FIG. 5E shows an example of obscured lines data.

FIG. 5G shows another example two page exhibit identifying detection of more sophisticated copying techniques.

FIG. 6 illustrates an example of a bulk compare system.

FIG. 7 shows an example of file pair combinations.

FIG. 8 shows an overall process including expert review.

FIG. 9 shows a process for reformatting and recalculating following expert review.

FIG. 10 shows a separate listings associated with a side-by-side listing.

FIG. 11 and FIG. 12 show examples of separate formatted file listings.

FIG. 13 shows a process for statistics update and individual file formatting.

### REFERENCE NUMERALS IN DRAWINGS

| | |
|---|---|
| 100 | File Compare System |
| 110 | File A |
| 120 | File B |
| 130 | File Compare |
| 140 | Operational Data |
| 150 | Formatted Report |
| 150a | File A Listing |
| 150b | File B Listing |
| 160 | File A Read Path |
| 162 | File B Read Path |
| 164 | Operation Data Read Path |
| 166 | Output Path |
| 180 | User Interface Options |
| 182 | UI Options Path |
| 2300 | Discovered Translations List |
| 2300a | Original Words |
| 2300b | Translation Equivalents |
| 2310 | Line 1 (Discovered Translations) |
| 2310a | First Original Word |
| 2310b | First Translation Equivalent |
| 2312 | Line 2 (Discovered Translations) |
| 2312a | Second Original Word |
| 2312b | Second Translation Equivalent |
| 2314 | Line 3 (Discovered Translations) |
| 2316 | Line 4 (Discovered Translations) |
| 2318 | Line 5 (Discovered Translations) |
| 2320 | Line 6 (Discovered Translations) |
| 2322 | Line 7 (Discovered Translations) |
| 2324 | Line 8 (Discovered Translations) |
| 2326 | Line 9 (Discovered Translations) |
| 2328 | Line 10 (Discovered Translations) |
| 2330 | Line 11 (Discovered Translations) |
| 2332 | Line 12 (Discovered Translations) |
| 2334 | Line 13 (Discovered Translations) |
| 2336 | Line 14 (Discovered Translations) |
| 2338 | Line 15 (Discovered Translations) |
| 2340 | Line 16 (Discovered Translations) |
| 2400 | Exhibit Name |
| 2400a | Body of File A |
| 2400b | Body of File B |
| 2402 | Confidentiality Legend |
| 2404 | Footer Name |
| 2406 | Page Information |
| 2408 | File A Pathname |
| 2410 | File B Pathname |
| 2420 | Separator Bar |
| 2430 | Statistics Section |
| 2432 | Total Lines Statistics |
| 2434 | Copied Lines Statistics |
| 2436 | Obscured Lines Statistics |
| 2438 | Filtered Lines Statistics |
| 2440 | Translation Comment |
| 2450 | Translations Found |
| 2452 | “quick = fast” Translation |
| 2460 | Notes |
| 3100 | Start 3100 |
| 3102 | Path 3102 |
| 3104 | Read File A Step |
| 3106 | Path 3106 |
| 3108 | Read File B Step |
| 3110 | Path 3110 |
| 3112 | Read Operational Data Files Step |
| 3114 | Path 3114 |
| 3116 | Compare Files Step |
| 3118 | Path 3118 |
| 3120 | Calculate Similarities Step |
| 3122 | Path 3122 |
| 3124 | Threshold Decision |
| 3126 | Path 3126 |
| 3128 | Output Reports Step |
| 3130 | Path 3130 |
| 3132 | Path 3132 |
| 3134 | Finish 3134 |
| 3200 | Start 3200 |
| 3202 | Path 3202 |
| 3204 | More Lines in File B Decision |
| 3206 | Path 3206 |
| 3208 | Find Next Match |
| 3210 | Path 3210 |
| 3212 | Matches Found Decision |
| 3214 | Yes Path |
| 3216 | Mark Matching Lines |
| 3218 | Path 3218 |
| 3220 | Look Back for Matches Step |
| 3222 | Path 3222 |
| 3224 | Path 3224 |
| 3226 | Mark Pending Lines of Both Files |
| 3228 | Path 3228 |
| 3230 | Final Look Back for Matches Step |
| 3232 | Path 3232 |
| 3234 | Do Remaining Lines of File A |
| 3236 | Path 3236 |
| 3237 | Path 3237 |
| 3238 | Finish 3238 |
| 3300 | Start 3300 |
| 3302 | Path 3302 |
| 3308 | Get and Tokenize Next Line of File B |
| 3310 | Path 3310 |
| 3312 | Determine Significant Tokens |
| 3314 | Path 3314 |
| 3316 | Any Significant Decision |
| 3318 | Path 3318 |
| 3320 | Path 3320 |
| 3326 | Get and Tokenize Next Line of File A |
| 3328 | Path 3328 |
| 3330 | Any Tokens Match Decision |
| 3332 | Path 3332 |
| 3334 | Path 3334 |
| 3336 | Increment Offsets and Block Sizes |
| 3338 | Path 3338 |
| 3340 | Offset > Start of File A Decision |
| 3342 | Path 3342 |
| 3344 | Path 3344 |
| 3346 | Get & Tokenize Previous Lines of Both Files |
| 3348 | Path 3348 |
| 3350 | Do Tokens Match Decision |
| 3352 | Path 3352 |
| 3354 | Path 3354 |
| 3356 | Adjust Both Offsets & Block Sizes |
| 3358 | Path 3358 |
| 3364 | Get and Tokenize Next Lines of Both Files |
| 3366 | Path 3366 |
| 3368 | Tokens Match Decision |
| 3370 | Path 3370 |
| 3372 | Increment Block Sizes |
| 3374 | Path 3374 |
| 3376 | Path 3376 |
| 3378 | Finish 3378 |
| 3400 | Start 3400 |
| 3402 | Path 3402 |
| 3404 | Append Stats Line to Stats File |
| 3406 | Path 3406 |
| 3408 | Open Output Files |
| 3410 | Path 3410 |
| 3412 | Output Formatted Headers |
| 3414 | Path 3414 |
| 3416 | Output Formatted File A Body |
| 3418 | Path 3418 |
| 3420 | Output Formatted File B Body |
| 3422 | Path 3422 |
| 3424 | Output Compare Statistics |
| 3426 | Path 3426 |
| 3428 | Close Files |
| 3430 | Path 3430 |
| 3432 | Finish 3432 |
| 400 | Alternate File Compare System |
| 430 | Alternate File Compare |
| 440 | Specific Operational Data Files |
| 442 | Discovered Translations |
| 444 | Suspected Translations |
| 446 | Exclusions |
| 448 | Obscured Lines |
| 452 | Statistics |
| 454 | New Possible Translations |
| 456 | Translations Used |
| 458 | Filter Translations |
| 464 | Operational Data Read Path |
| 468 | Additional Output |
| 470 | Language Specific |
| 472 | Language Keywords |
| 480 | Advanced User Interface Options |
| 482 | Path 482 |
| 5300 | Alternate Discovered Translations |
| 5300a | Alternate Original Words |
| 5300b | Alternate Translation Equivalents |
| 5310 | Line 1 (Alternate Discovered Translations) |
| 5310a | First Alternate Original Word |
| 5310b | First Alternate Translation Equivalent |
| 5312 | Line 2 (Alternate Discovered Translations) |
| 5312a | Second Alternate Original Word |
| 5312b | Second Alternate Translation Equivalent |
| 5314 | Line 3 (Alternate Discovered Translations) |
| 5316 | Line 4 (Alternate Discovered Translations) |
| 5318 | Line 5 (Alternate Discovered Translations) |
| 5320 | Line 6 (Alternate Discovered Translations) |
| 5322 | Line 7 (Alternate Discovered Translations) |
| 5324 | Line 8 (Alternate Discovered Translations) |
| 5326 | Line 9 (Alternate Discovered Translations) |
| 5328 | Line 10 (Alternate Discovered Translations) |
| 5330 | Line 11 (Alternate Discovered Translations) |
| 5332 | Line 12 (Alternate Discovered Translations) |
| 5334 | Line 13 (Alternate Discovered Translations) |
| 5336 | Line 14 (Alternate Discovered Translations) |
| 5338 | Line 15 (Alternate Discovered Translations) |
| 5340 | Line 16 (Alternate Discovered Translations) |
| 5342 | Line 17 (Alternate Discovered Translations) |
| 5344 | Line 18 (Alternate Discovered Translations) |
| 5400 | Suspected Translations |
| 5400a | Suspected Original Words |
| 5400b | Suspected Translation Equivalents |
| 5410 | Line 1 (Suspected Translations) |
| 5410a | First Suspected Original Word |
| 5410b | First Suspected Translation Equivalent |
| 5412 | Line 2 (Suspected Translations) |
| 5500 | Exclusions List |
| 5500a | Expressions |
| 5500b | Comments |
| 5510 | Line 1 (Exclusions) |
| 5510a | First Expression |
| 5510b | First Comment |
| 5512 | Line 2 (Exclusion) |
| 5512a | Second Expression |
| 5512b | Second Comment |
| 5600 | Obscured Lines List |
| 5600a | Obscured Lines Start A |
| 5600b | Obscured Lines Block A |
| 5600c | Obscured Lines Start B |
| 5600d | Obscured Lines Block B |
| 5600e | Obscured Lines File |
| 5610 | Line 1 (Obscured Lines) |
| 5610a | Line 1 Start A |
| 5610b | Line 1 Block A |
| 5610c | Line 1 Start B |
| 5610d | Line 1 Block B |
| 5610e | Line 1 File |
| 5612 | Line 2 (Obscured Lines) |
| 5768 | Exclusions Note |
| 5770 | Exclusion Comments Used |
| 5772 | Integer Exclusion |
| 5774 | Comment Exclusion |
| 600 | Bulk Compare System |
| 610 | File Set A |
| 612 | File A1 |
| 614 | File A2 |
| 616 | File A3 |
| 618 | File A4 |
| 620 | File Set B |
| 622 | File B1 |
| 624 | File B2 |
| 626 | File B3 |
| 630 | Bulk Compare |
| 632 | Bulk User Interface |
| 634 | Path 634 |
| 638 | Path 638 |
| 652 | Bulk Statistics |
| 654 | Possible Translations |
| 660 | Path 660 |
| 662 | Path 662 |
| 664 | Path 664 |
| 668 | Path 668 |
| 680 | Bulk User Interface Options |
| 700 | File Pair Combinations |
| 700a | A Files |
| 700b | B Files |
| 710 | A1-B1 Pair |
| 710a | First A File |
| 710b | First B File |
| 712 | A1-B2 Pair |
| 714 | A1-B3 Pair |
| 716 | A2-B1 Pair |
| 718 | A2-B2 Pair |
| 720 | A2-B3 Pair |
| 722 | A3-B1 Pair |
| 724 | A3-B2 Pair |
| 726 | A3-B3 Pair |
| 728 | A4-B1 Pair |
| 730 | A4-B2 Pair |
| 732 | A4-B3 Pair |
| 740 | A1 to B1, B2, B3 Set |
| 742 | A2 to B1, B2, B3 Set |
| 744 | A3 to B1, B2, B3 Set |
| 746 | A4 to B1, B2, B3 Set |
| 800 | Start 800 |
| 810 | Path 810 |
| 812 | Perform Bulk Compare |
| 814 | Path 814 |
| 816 | Analyze Statistics |
| 818 | Path 818 |
| 820 | Expert Review |
| 822 | Path 822 |
| 824 | Get Next Pair |
| 826 | Path 826 |
| 830 | Done Decision |
| 832 | Path 832 |
| 834 | Perform File Compare |
| 840 | Path 840 |
| 850 | Path 850 |
| 860 | Finish 860 |
| 900 | Start 900 |
| 902 | Path 902 |
| 906 | Path 906 |
| 908 | Manually Modify Markup |
| 910 | Path 910 |
| 912 | Reformat and Recalculate Statistics |
| 914 | Path 914 |
| 916 | Finish 916 |
| 1000 | Statistics update and separate file formatting |
| 1004 | Path 1004 |
| 1006 | Formatted Listing A |
| 1008 | Path 1008 |
| 1010 | Formatted Listing B |
| 1100 | Listing Exhibit Name |
| 1100a | Listing Body of File |
| 1102 | Listing Confidentiality Legend |
| 1104 | Listing Footer Name |
| 1106 | Listing Page Information |
| 1108 | Listing File Pathname |
| 1300 | Start 1300 |
| 1302 | Path 1302 |
| 1304 | Parse Compare File & Calculate Statistics |
| 1306 | Path 1306 |
| 1308 | Output File A Listing |
| 1310 | Path 1310 |
| 1312 | Output File B Listing |
| 1314 | Path 1314 |
| 1316 | Output Compare File with Updated Statistics |
| 1318 | Path 1318 |
| 1320 | Finish 1320 |

### DESCRIPTION OF THE INVENTION

The present invention comprises a comprehensive system that will automatically compare sets of files to determine what has been copied even when sophisticated techniques for hiding or obscuring the copying have been employed.

### Basic System

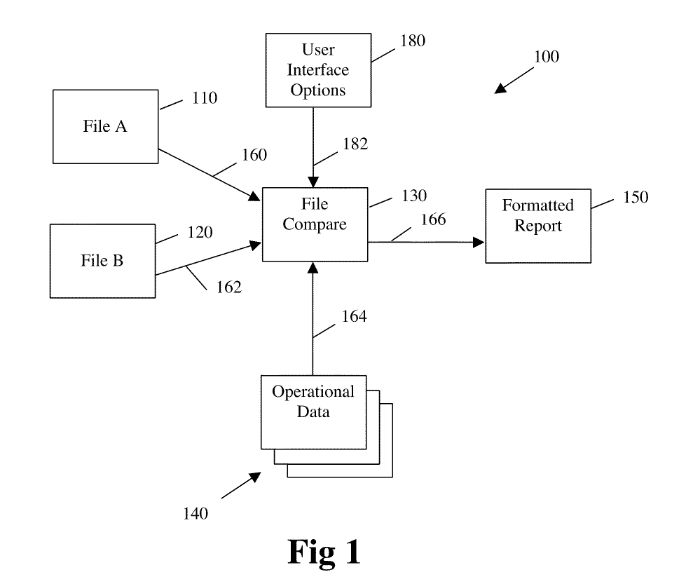

FIG. 1 illustrates the basic components of the inventions. In this exemplary embodiment, a file compare system 100 is provided which compares two files, file A 110 and file B 120, respectively. These files are read by the system as represented by paths 160 and 162 respectively.

The file compare 130 engine is implemented by a computer. It could be implemented in hardware or software. A hardware version of the file compare 130 engine, a file compare machine, would have some speed advantages but would be more expensive to implement and more difficult to modify. A software version of the file compare 130 engine, a file compare program, would be less costly to implement and would be easier to maintain and distribute. Regardless of implementation, the file compare 130 engine would perform the same function in the system. For ease of discussion, the file compare 130 engine will hereafter be referred to as the file compare program 130; however, the use of these terms are not meant to limit the scope of the invention to a software only implementation.

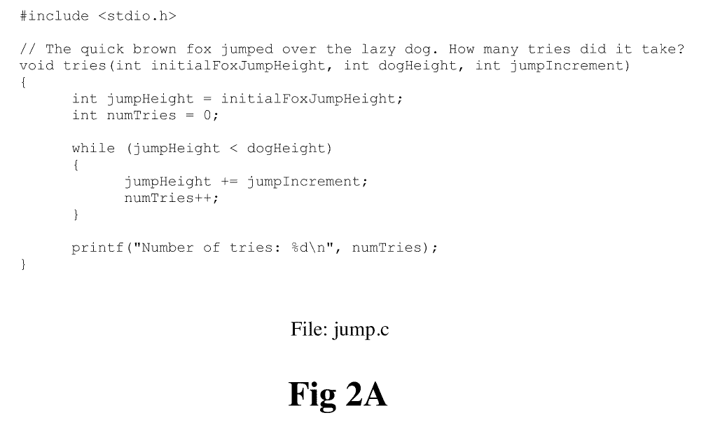

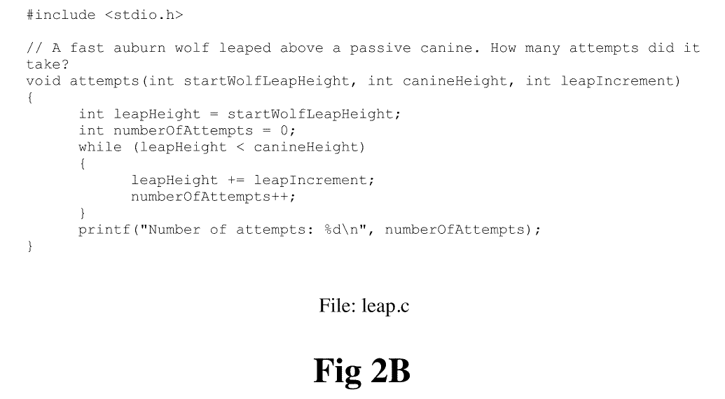

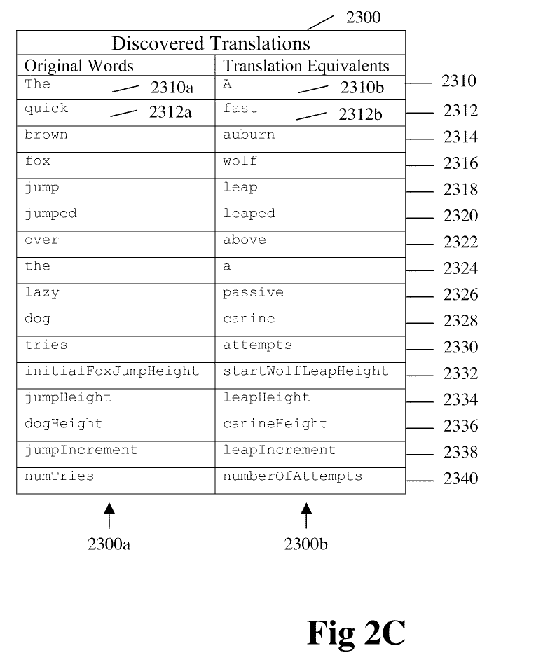

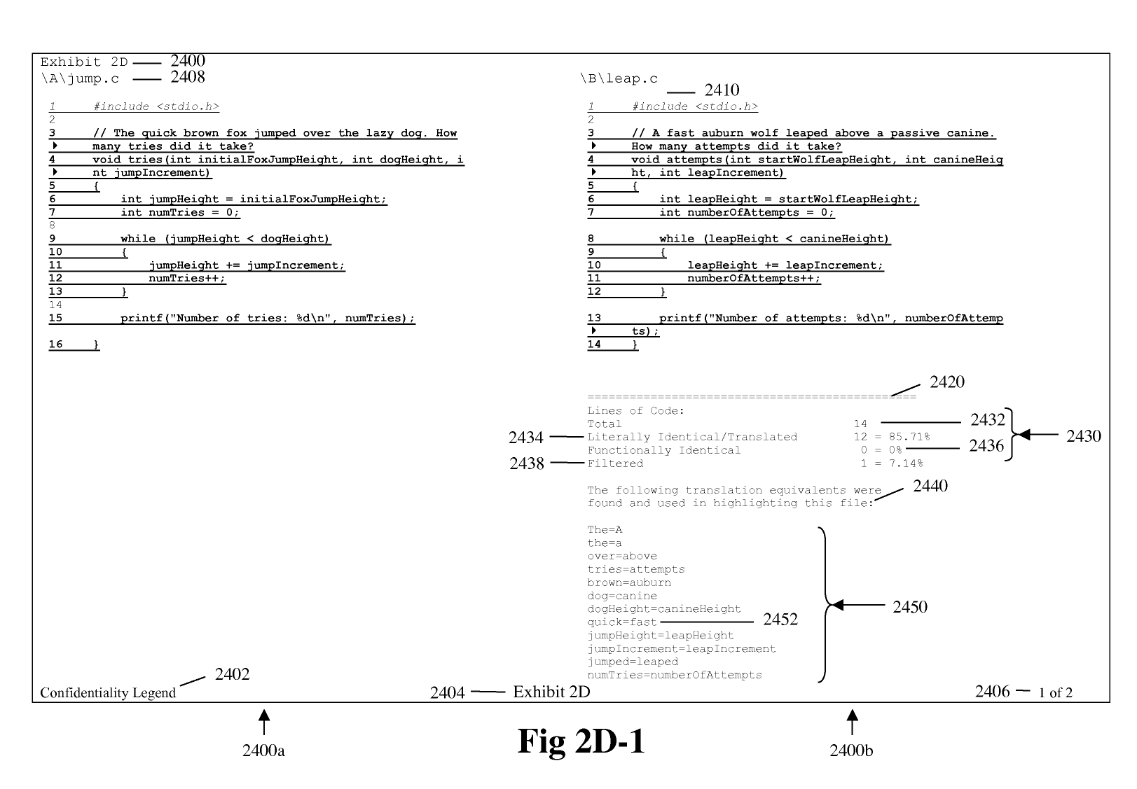

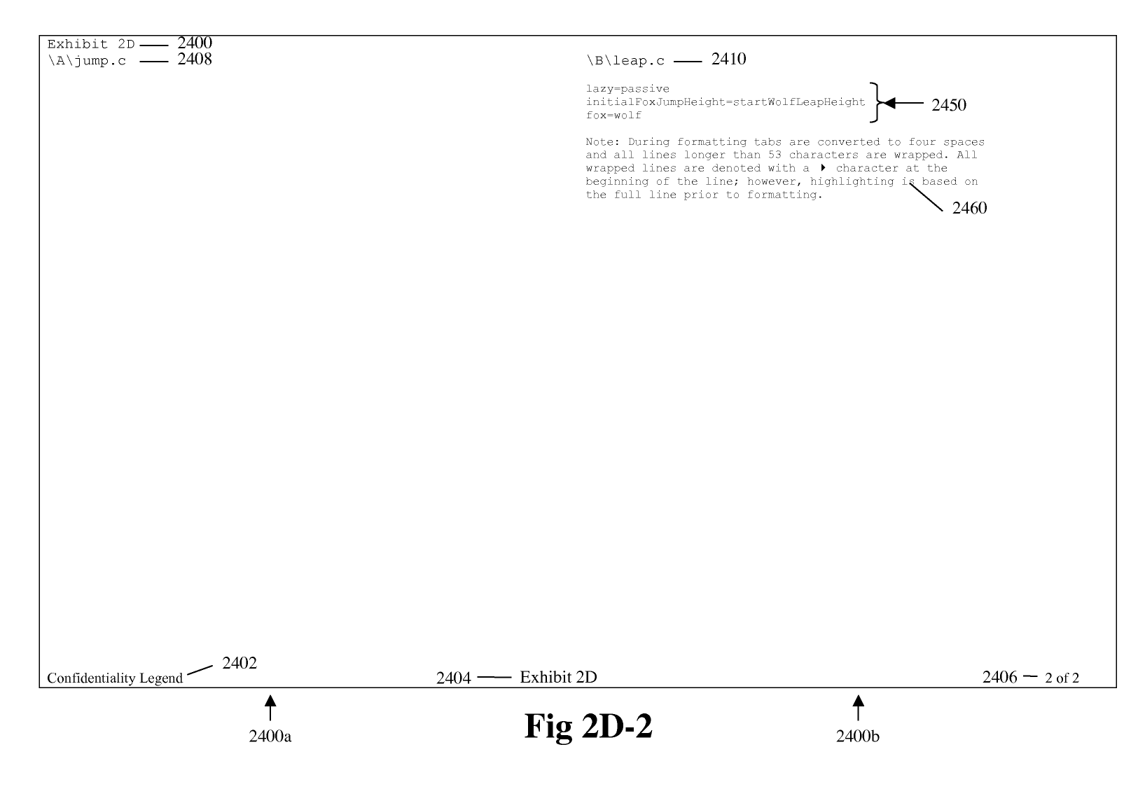

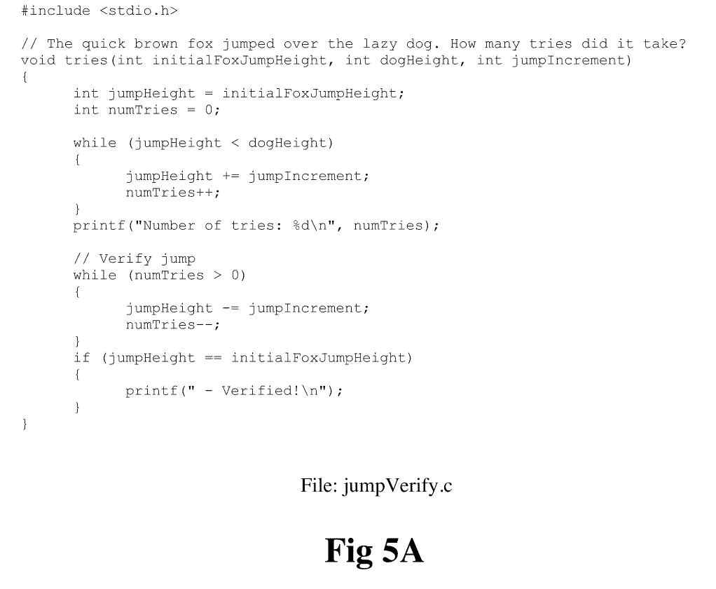

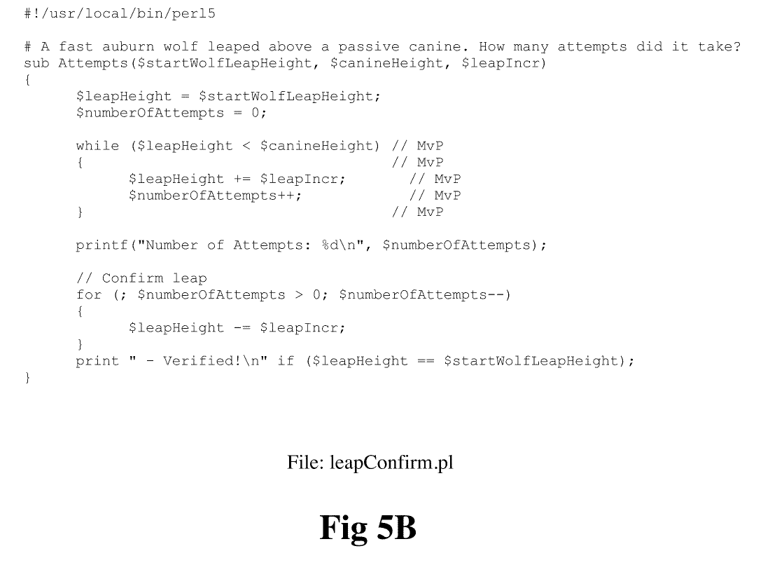

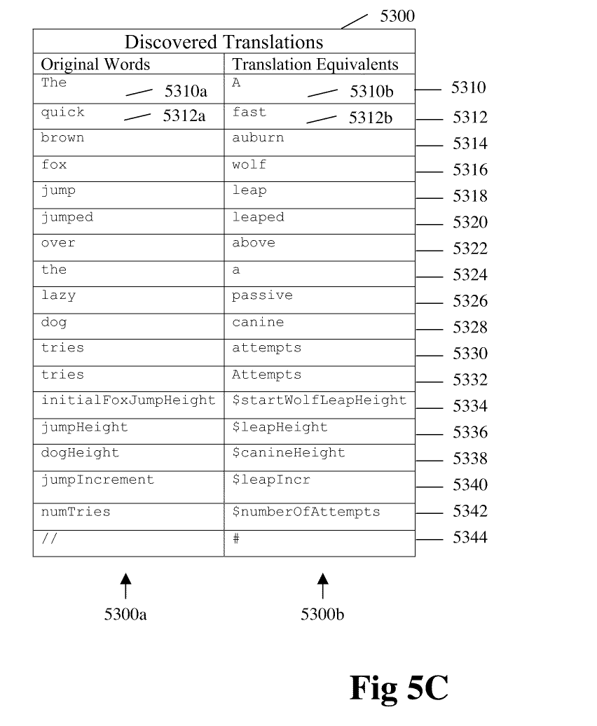

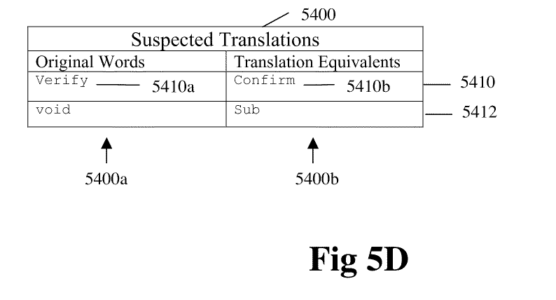

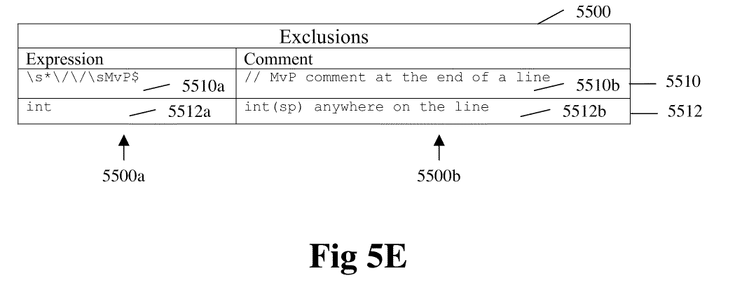

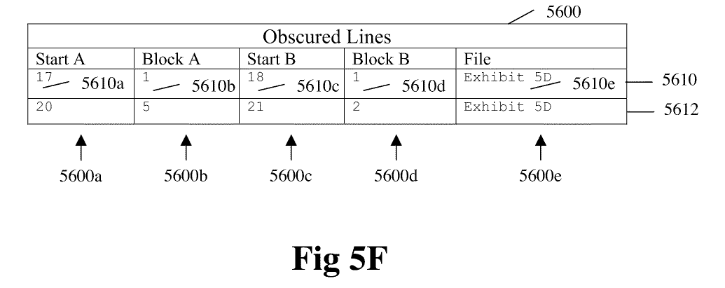

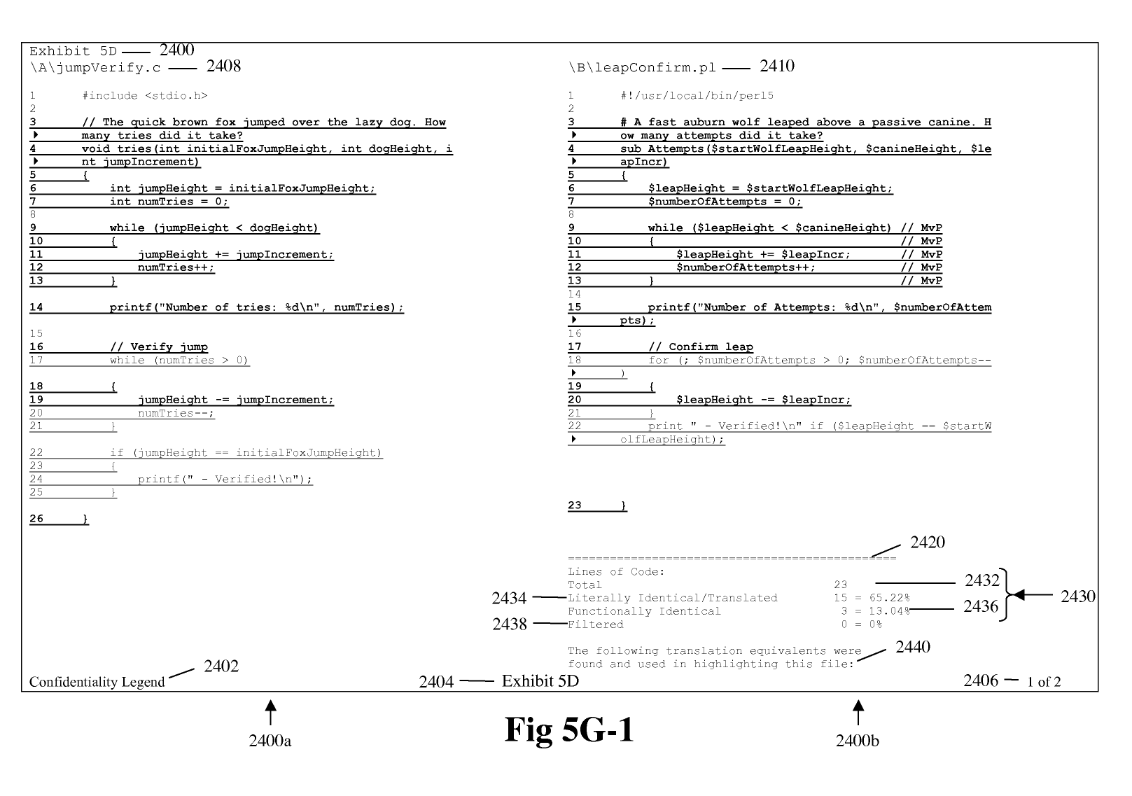

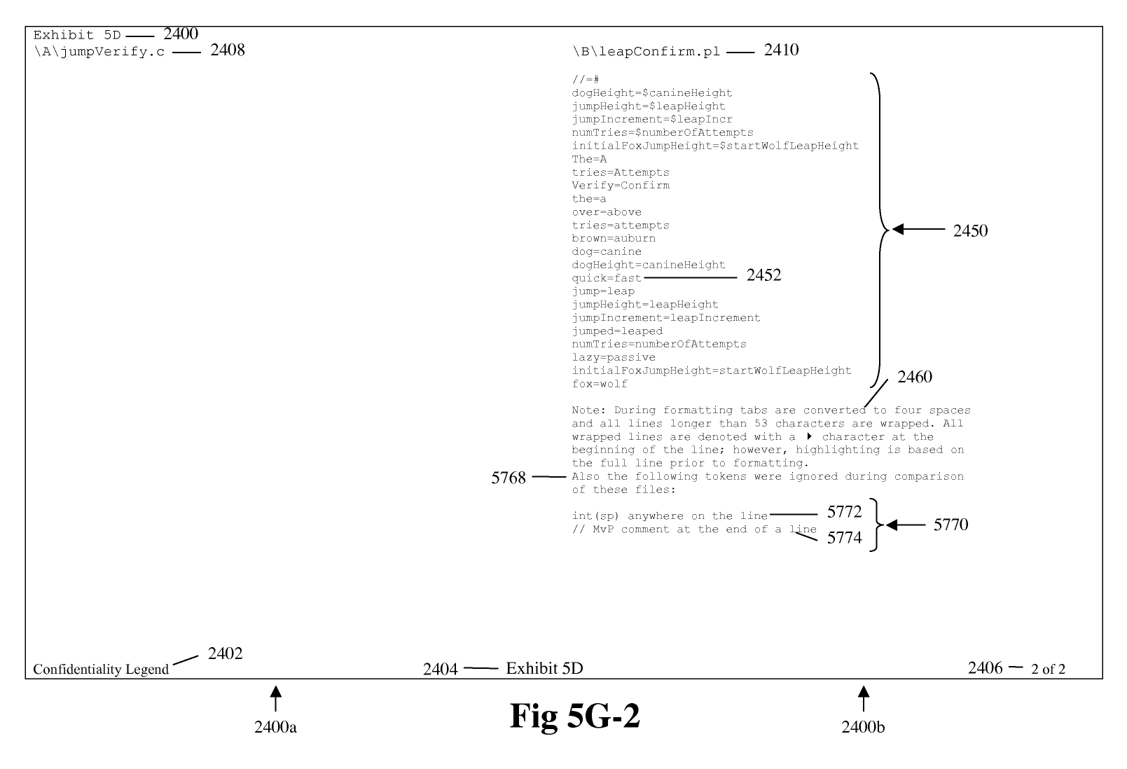

The system further comprises operational data 140 that is used in performing the comparison, detection of copying, and other functions. One type of operational data 140 is list of discovered translations, which correlates pairs of words the user (typically, a computer forensic expert) discovers to have been used to obscure copying. Examples of discovered translations are explained in reference to discovered translations list 2300 (FIG. 2C) and alternate discovered translations 5300 (FIG. 5). A novel feature of this invention is that discovered translations are stored in a discovered translation file 442 (see FIG. 4). This allows for different discovered translation data to be used from different pairs of files without changing the file compare program 130.

The file compare program 130 outputs a formatted report 150. A novel feature of this invention is that the size (e.g. legal or letter) and layout (e.g. landscape or portrait) of the report as well as various headers and footers and formatting options can be selected without changing the file compare program 130.

The file compare program 130 operates as directed in part by the user according to various user interface options 180. For example, the user is able to specify which one of several discovered translations files should be used with a particular pair of files. The user interfaces options 180 are set by the user using a user interface 182, either a command line interface, a graphical user interface, or both. Alternatively, the user interface options can be specified in a script file that is read along path 182.

### Example Files

FIGS. 2A and 2B shows example files. In this example, as shown in FIG. 2A, file A 110 is named jump.c, and as shown in FIG. 2, file B 120 is named leap.c. In this example the files are both written in the same computer programming language called the C Programming Language, or just C. At first glance, these two files do not appear to be similar or that one is a copy of another. The present invention provides a way to automatically detect and format a report that will show the true similarity between these two files.

### Discovered Translations

FIG. 2C shows an example of discovered translations list 2300 data. The original words 2300a from file A are shown in the first column. The translation equivalents 2300b found in file B are shown in the second column. Each row of data represents correlated pairs of words, which the user (typically, a computer forensic expert) discovers and confirms have been used to obscure copying. The first line 2310 contains a correlated pair of words. The second line 2312 contains a second pair of words. Lines 3 through 16 are identified by reference numbers 2314, 2316, 2318, 2320, 2322, 2324, 2326, 2328, 2330, 2332, 2334, 2336, 2338, and 2340, respectively.

For example, the second line 2312 shows the words “quick” 2312a and “fast” 2312b as words that in the context of this comparison have been translated. The original file (file A as shown in FIG. 2A) contains a comment that includes “The quick brown fox jumped over the lazy dog.” At first glance, the contents of file B (as shown in FIG. 2B) appears to be totally different. However upon close inspection, the similarities start to become apparent. For example, file B also starts with a comment, “A fast auburn wolf leaped above a passive canine” Although none of the words are an identical match, a comparison of each word from file A with the corresponding words of file B reveals that each word has been substituted with a translation equivalent. Further comparison and analysis reveals that the variable names also have been changed, most likely with a global change as discussed above. For example, “jumpHeight” has been changed to “leapHeight” (see row 2334). The translated computer program (e.g. FIG. 2B) functions in exactly the same way as the original program (e.g. FIG. 2A) even though the names have been changed.

Although this is a simple example with only two files, in a real copyright infringement case there are many tens of thousands of files in each set of files and millions of lines of code. The same variables, such as “jumpHeight” in this example, may occur in thousands of different files. Once the expert is able to find the first few translations, it becomes like a Rosetta Stone for understanding the other translations that have been made through the copied files. Each discovered translations file, for example as shown in FIG. 2C, becomes a Rosetta Stone for understanding and detecting the translations that have been used to obscure illicit copying.

To demonstrate the similarities between these two files so that the court and it's triers of fact, the judge and the jury, can see what the expert sees, it is useful to prepare a side-by-side exhibit.

### Formatted Report

FIG. 2D shows an exemplary exhibit, entitled Exhibit 2D 2400, which contains a side-by-side listing comparing files from the exemplary file A of FIG. 2A and file B of FIG. 2B. The file A version is shown on the left and the file B version is shown on the right. In the exhibits produced by the file compare program 130, lines of code that have been literally copied or translated are shown in red and are underlined (for example, see line 3). Lines of code that are not literally identical, but are technically equivalent due to insubstantial differences are shown in blue and are underlined (see FIG. 5G for an example). Lines that were copied but have been filtered are shown in magenta and are underlined and in italics (for example, see line 1).

The use of underline and italics allow for black and white copies to be useful even though the full color exhibits will be used in the courtroom.

The body of the report contains the lines from file A (FIG. 2A) on the left, the body of file A 2400a and file B (FIG. 2B) on the right, the body of file B 2400b. Note that the matching code has been aligned. For example, line 14 of file A (2400a) was deleted after it was copied to file B (see between line 12 and 13 in 2400b). The file compare program 130 inserts an unnumbered line on the right so that the copied lines still line up side-by-side. The absence of the line number indicates to the court how the original evidence was different while still shedding light on the high degree of copying. Once the expert has used the file compare program 130 of the invention to automatically line up and highlight the various types of copying the judge and jury can more easily see the degree of copying and the level of intentional obscuration and judge for themselves.

The colors and font styles are exemplary. The use of other colors or styles as indicators of the various types of copying is anticipated by this invention.

Other aspects of the formatted reported 150 (FIG. 1) are the exhibit name 2400, which can be set by the user via the user interface options 180 (FIG. 1) and the respective path names, file A pathname 2408 and file B pathname 2410. The footer of the report includes a confidentiality legend 2402. This also will vary from project to project base on various court protective orders. For example, the confidentiality legend might read, “CONFIDENTIAL—Under Protective Order”, “HIGHLY CONFIDENTIAL—Outside Attorney's Eyes Only”, or “RESTRICTED SOURCE MATERIALS”. The legend 2402 could also include the name of the expert who is producing the exhibit. The footer may also include an exhibit name 2404 and page information 2406, which is helpful for finding the right exhibit and page during testimony or discussions. The page information preferably includes both the page number and the number of pages in the exhibit.

Following the data from file B is a separator bar 2420, which indicates the beginning of a section of the report that presents statistics and other information that would be helpful to the court. The statistics section 2430 include:

total lines statistics 2432

copied lines statistics 2434

obscured lines statistics 2436

filtered lines statistics 2438

These statistics in the statistics section 2430 show how much of the material was literally copied or literally translated, how much was copied but obscured by making insubstantial changes which prevent precise word for word or line for line matching, and how much was copied but would be permissible copying. These statistics are helpful in making the legal and factual determination of “substantial similarity” and whether the copying itself was substantial. The sum of the statistics over the entire body of copied code, will have a major impact on the decision of the court. Thus it is important that these statistics be correct.

The report also makes full disclosure of which translation equivalents were found and actually used in the copied file. This too allows the judge and jury to see for themselves what the expert has found and confirm the accuracy of the experts work. This section of the report starts with the translation comment 2440, and is followed by a list of translations found 2450. For example, the “quick=fast” translation 2452 was actually used to obscure the copying in leap.c. This detection was facilitated based on one entry in the discovered translations list 2300 (FIG. 2C), in particular line 2 (2312) with the correlation of “quick” 2312a and “fast” 2312b.

The report concludes with other notes 2460 (see FIG. 2D-2), which provide a full disclosure to the court of how the original evidence was modified from its original form in the preparation of this type of more illuminating exhibit. This disclosure is important to avoid allegations that the expert “tapered with the evidence”. These notes explain another novel aspect of the invention. Rather than truncating long lines (which may fail to show important information), lines that will not fix in the allocated area are automatically wrapped. A special symbol such as an arrowhead or underbar is used on the beginning of a wrapped line, instead of a line number, to indicate that it is a continuation of the previously numbered line.

### File Compare Operation

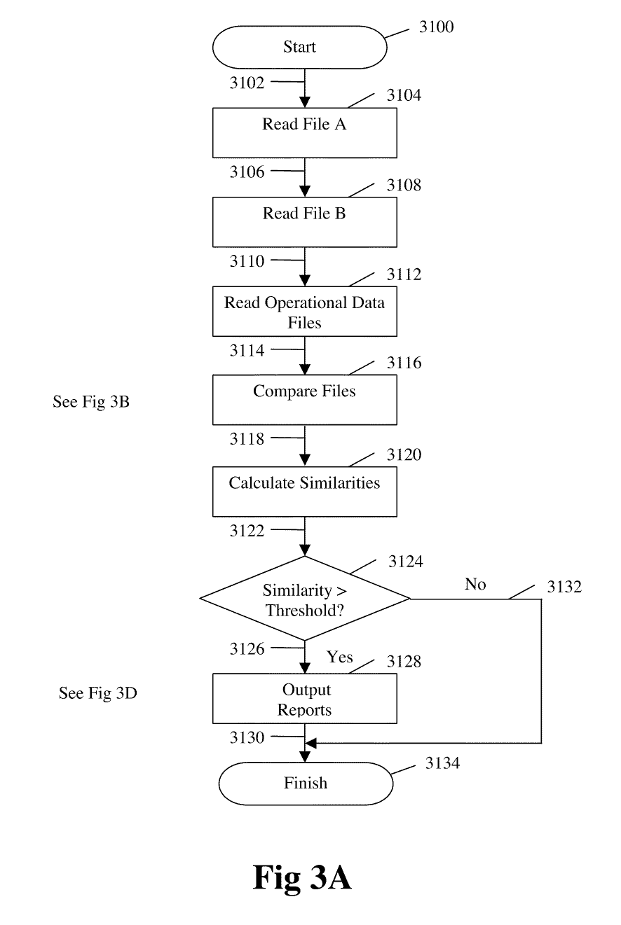

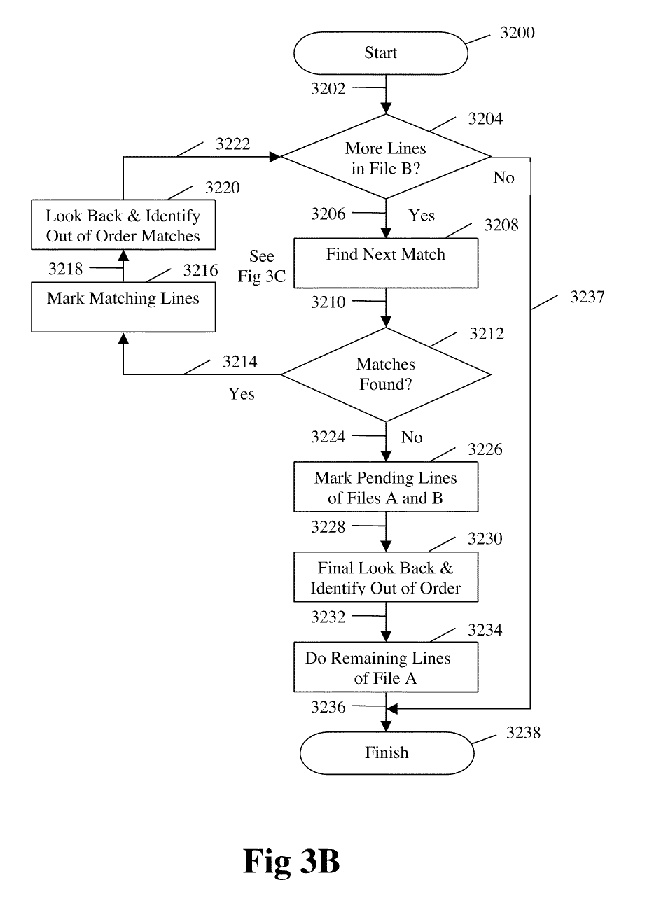

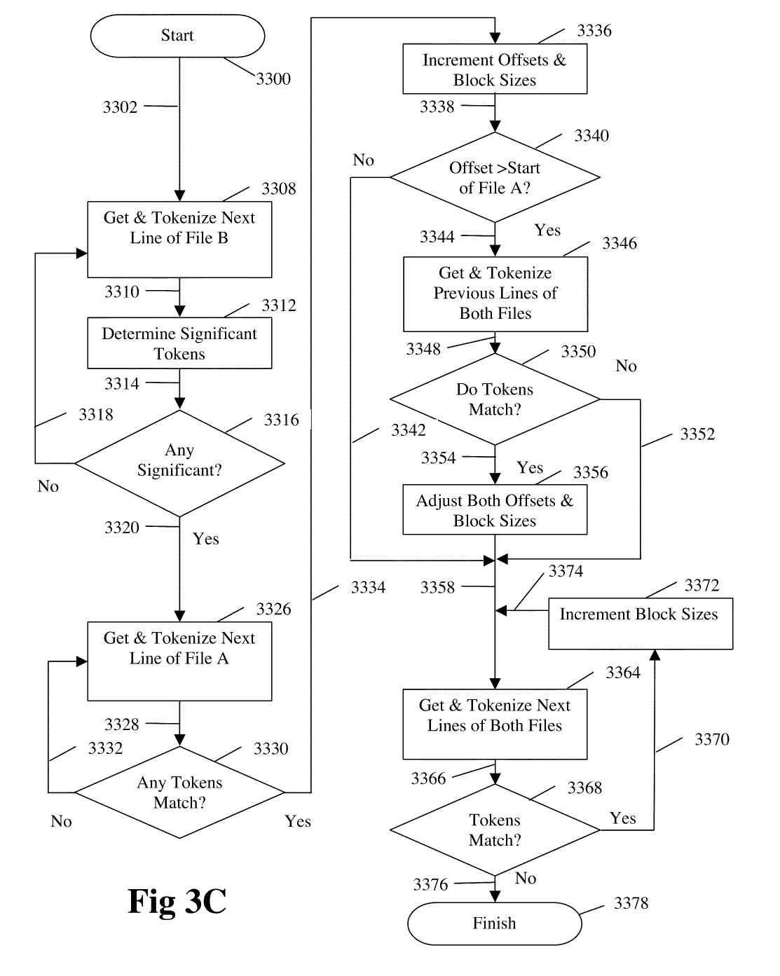

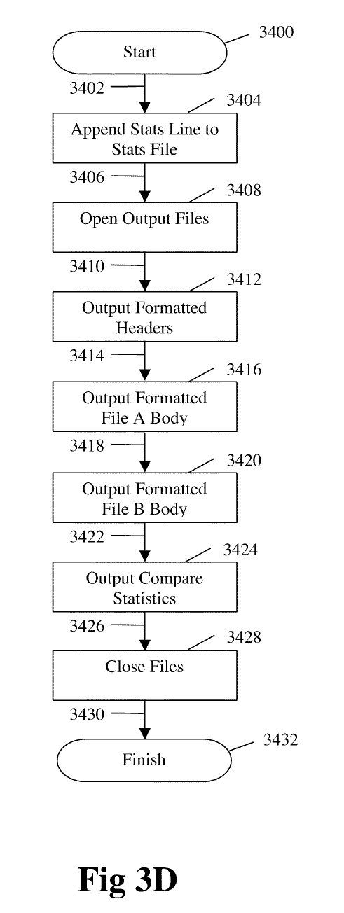

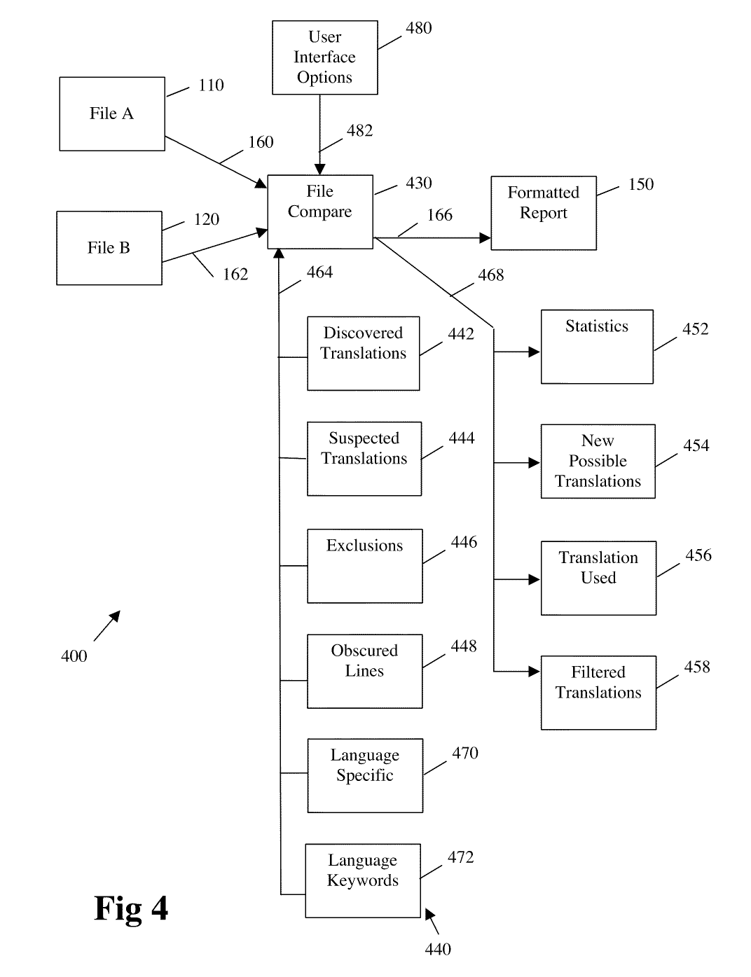

FIGS. 3A through 3D show flow charts for the file compare program 130. Good results have been obtained by implementing the file compare program 130 in the Perl programming language, but the file compare could be implemented in another computer programming language, such as C, C++, or java. Perl is a cross platform language which allows for the same program to be run on multiple platforms, such as a PC running Windows brand operation systems or a Macintosh brand computer running MacOS brand operating systems.

The flow charts (FIG. 3A through 3D) illustrate the methods used by an embodiment of file compare program. Those skilled in the art would understand that various changes can be made to the basic flow chart to provide various features of the present invention.

FIG. 3A is a flow chart of the main program. The program starts at entry point 3100, where user interface options 180 are evaluated to determine which files to compare and what other operational data is needed. The program flow continues along path 3102 to a read file A step 3104, where the contents of file A are read into a portion of the computer's memory. This data is kept in memory until the processing associated with this file is complete. The processing of this invention is very data intensive and reading all the data into memory at the beginning has proven to enhance performance. However those of ordinary skill in the art would recognize that a trade off between speed and resource consumption could be made. Flow continues along path 3106 to a read file B step 3108, where the contents of file B are read into memory.

Flow continues along path 3110 to a read operational data files step 3112, where one or more operational data 140 files are read. In order to achieve the translation detection features of the present invention, at least one discovered translations file (see explanation regarding Exhibit 2C) must be read. This dynamically loads the discovered translation data (e.g. 2300 or 5300) that is appropriate for the pair of files being compared. Loading the discovered translations data from files allows for different discovered translations to be used for different sets of files, without having to modify the file compare program 130.

Flow continues along path 3114 to a compare files step 3116 where the contents of the files are compared using the various user interface options 180 and operation data 140. This step will be broken down into more detail in reference to FIG. 3B.

Flow continues along path 3118 to a calculate similarities step 3120, and then along path 3122 to the threshold decision 3124. The user interface options 180 may be used to specify a similarity threshold, such as 1%. If the similarity of the files is less than the specified threshold, the file compare program 130 may be directed to skip the output production. This is a novel feature of this invention that saves time and resources by not producing formatted reports 150 that may not be desired. The computer processor may be more efficiently used to compare other files. The storage space of the computer can be reserved for report files that are of greater interests.

If the similarity is greater than the specified threshold, processing continues along path 3132 where resources are released and the program is ready to perform another file compare. Otherwise, flow continues along path 3126 to the output reports step 3128 where the desired reports are output. This step will be broken down into more detail in reference to FIG. 3D. Then, processing continues along path 3130 where resources are released and the program is ready to perform another file compare. The main program in this embodiment is finished 3134. However, as will be discussed later, the main program may be used as a sub-step of other embodiments of this invention.

FIG. 3B is a flow chart detailing the compare files step 3116 (FIG. 3A). After entering at entry point 3200, the programs checks to see if file B has lines that are not yet processed (more lines in file B decision 3204). Unless the file is empty, the first time through there will always be something to look at. If there are more lines in file B, flow continues along path 3206 to a find next match 3208 step, which is broken out into greater detail in FIG. 3C. If a match can be found, the matches found decision 3212 will result in flow continuing along the yes path 3214. At a mark matching lines 3216 step, the matching lines will be marked as literally copied or literally translated. This status is kept in a data structure that maintains the status of every line in each file. Initially the status is unknown. When a successful match is found the lines that match (as indicated by an index or offset into each data structure), the corresponding line status is updated.

Flow continues along path 3218 to a look back for matches step 3220. Because were have been looking at matches based on lines in only one file, it is possible that the match just found has been copied multiple times. In order to have accurate statistics and highlighting showing the level of copying it is important to mark every instance of copying. In this step, the program looks back at all of the previously processed lines to see if it matches a line that has just been determined to have been copied. This effectively finds multiple copies that have been obscured by moving them out of order, or by duplicating sections of the code so that it appears that the copied code is not similar in structure to the original code. This ability to automatically detect, highlight and account for this type of obscured copying also is a novel feature of this invention.

If no matches were found at step 3208, it will be decided at decision point 3212 to continue along path 3224. At this point all the matches have been found, but the pending lines need to be processed to indicate status. This happens at the mark pending lines of both files 3226 step. Next as explained above, it is necessary to go back and look for any out of order matches or multiple copied lines in the lines that have not yet been processed. Finally, there are lines in the final portion of file A that were not yet checked when there were no more lines in File B. Flow continues along path 3232 to the remaining lines of file A step 3234. Then the flow finishes at 3238 and returns to path 3118 (FIG. 3A).

FIG. 3C is a flow chart detailing the find next match step 3208 (FIG. 3B). Note that this is the third level of nested flow charts and this represents the tightest loop of the program. At the higher levels, processing is focused on lines and determining their status and alignment. This level is focused on breaking the line down into meaningful words or symbols (called tokens) and applying the various matching rules to determine if the current line for file B is a literal copy or a literal translation of a line from the original file A. The process of breaking down lines into tokens is called tokenizing. A number of novel techniques are applied at this level to overcome various nefarious techniques used by the illicit copiers.

What is a meaningful token in one language may not be meaningful or have a different meaning in a different language. For example, in one language an asterisk ‘*’ can indicate the beginning of a comment, while in another language it means to multiply. The meaning may also be based on position on the line. In one embodiment of the invention, the rules for how to break a line down into tokens is supplied by operation data stored in the file compare program 130. In another embodiment of the invention, tokenizing rules are stored in a file. In yet another embodiment of the invention there are multiple sets of language specific operation data 140. User interface options 180 specify which tokenizing rules are to be used for file A and specify a different set of rules to be used for tokenizing file B. In still yet another embodiment of the invention, the file compare program 130 uses other operational data to automatically determine which language from a set of known languages each file is written in, and then applies at least in part tokenizing rules base on the automatically determine language type.

Another novel aspect of the invention that is implemented at this level is the ability to exclude certain portions of lines or certain patterns of tokens or characters from consideration during token matching. One example of the need for this is a programming environment that places line number in a certain area of each line. In one embodiment of this invention, as will be discussed in more detail later in relation to FIG. 4 and FIG. 5E, one of the types of operation data is a list of items to be excluded. The exclusions (see FIG. 5E) can be specified as expressions. These expressions could indicate certain positions in the line to exclude, or they could indicate certain patterns such as comments that have been added to copied lines. Further, the exclusions could be hiatus words, which are optionally added or removed in a language without really affecting the function of the program.

One of ordinary skill in the art would recognize that these novel aspects, as explained above could all be implemented within the general program flow as disclosed in FIG. 3C, which will now be explained in detail.

Referring to FIG. 3C, after entering at entry point 3300, the program continues along path 3302 to the get and tokenize next line of file B 3308 step. In this step the line of data (that has previously been read from file B) is pointed to with an index called an offset and the line is broken down into meaningful tokens by applying either the default or special rules. In the various embodiments of the invention, the user interface options 180 and operational data 140, alter the tokenizing that occurs in this step to provide the optimum set of resulting tokens.

Flow continues along path 3310 to a determine significant tokens 3312 step, where it is determined whether or not there are any tokens which are significant. Significance could also vary from project to project or language to language as determined by user interface options 180 and operation data 140. For example, it is common in the C language to have a line with just a “}” (indicating the end of an if block) followed with just the word “else” followed by just a “{” (indicating the beginning of an else block). If these tokens are the first tokens to match after non-matching lines, it is hard to know if they are part of a larger block of copied code. These tokens in C would be considered insignificant because by themselves they are not strong evidence.

Flow continues along path 3314. If there were no significant tokens (as decided at the any significant decision 3316 point), flow returns to step 3308 where the next line of file B is tokenized as explained above. This loop continues and skips lines of little significance, until a line with significant tokens is found. When this happens, flow continues along path 3320 to a get and tokenize next line of file A 3326 step. This step is similar in function to step 3308, except it operates on a line from file A. Here also various special features of the various embodiments of the invention are implemented. The result is a list of meaningful tokens from the current line of file A.

Flow continues along path 3328 to an any tokens match decision 3330. If the meaningful tokens of the current line of file B, match the meaningful tokens of the current line of file A, there is a matching line. It is at this decision point where the discovered translations (e.g. 2300 or 5300) are applied. At this point a token matches if it is literally the same, or if the original word (e.g. 2300a or 5300a) from file A is found at the same token position as the translation equivalent (e.g. 2300b or 5300b) from file B. If the discovered translation is used to make a match, the line is considered to be literally translated. The lines are only marked as a match if all the non-excluded tokens match.

Note that if some tokens match but others tokens don't match, the program may have found a line that in fact has been copied but contains a yet unknown (undiscovered) translation. At this point in the process, the invention provides a novel feature. It keeps a record of token pairs that cause an otherwise matching line to fail the “tokens match?” test (3330, 3350, and 3368). In most embodiments of the invention these possible, but yet unverified, translations are output to a new possible translations 454 file (FIG. 4).

If the token match fails, flow continues along path 3332 back to step 3326 where the next line of file A is tokenized, as explained above. Otherwise, if all of the tokens match, flow continues along path 3334 to the increment offsets and block sizes 3336 step. At this point, the program has found at least one matching line in each file. If a block of code was copied, it is likely that the next line will also have been copied, so the program starts to keep track of the possible block of copied lines. At step 3336, the program increments its offsets to point to what would be the next line in the block in both files, it also increments variable(s) keeping track of the size of the matching blocks.

Flow continues along path 3338 to an offset>start of file A decision 3340. As mentioned above the program has found at least one significant line with all matching tokens. Because the programming has been skipping possibly matching tokens because they were not significant, the program can at this point look back at the previous line to see if it would have matched had it not been for the significance check. At decision 3340, the program checks to see if the current (incremented) offset for file A is greater than the start of the matching block for file A (i.e. is this the first line in the block), if it is then there might be a skipped line that was indeed copied, the program goes back to reclaim it. In this case, the program flow continues along path 3344 to the get and tokenize previous lines for both files 3346 step. At this step, the immediately previous line of each file is tokenized without checking for significance, and flow continues along path 3348 to a do tokens match decision 3350 (which is identical in function to decisions 3330, and 3368 which follows). If the tokens of the previous lines match, then flow continues along path 3354 to the adjust both offsets & block sizes 3356 step, where the offsets and block sizes for both files are adjusted to include the previously skipped line. Although not shown, in one embodiment flow could return step 3346 where more than one skipped line could be reclaimed. However, as shown, after step 3356, flow would continue along path 3358.

If at decision 3340, the program is not at the first match in a block, then flow also continues along path 3358. Likewise if the previous line that had been skipped didn't match, then flow continues along path 3358.

At this point the program has at least one matching line, and may have gone back and reclaimed matching lines that were skipped because they were insignificant. The program has found what it was designed to find, so it keeps going. At step 3364, it gets the next line for each file and tokenizes them (using the same rules as described in relations to step 3308, 3326, and 3346), and the checks to see if all the tokens match at 3368. If another line of the block matches, then flow continues along path 3370 to increment block sizes 3372 step, where the block sizes are incremented to show the growing block of matching code. Otherwise, when none of the tokens match at the current offsets (i.e. the offsets are at the end of a matching block), flow continues along path 3376, where the flow finishes at 3378 and returns to path 3210 (FIG. 3B).

In summary, the call to “Find Next Match” at 3208, moves through the data from both files until a match is found. When it returns, the program variables provide information about an entire block of literally copied or literally translated lines. This entire block is then marked at step 3216 and the look back for out of order matches step at 3320 has the entire block of new matches to consider.

As explained in this section, a number of the novel aspects of the invention are implemented by applying user interface options 180 or operation data 140 in the steps and decisions made during tokenizing of lines and comparing of tokens. Many embodiments have already been discussed. A novel aspect of the present invention is that these features can be added or adjusted by modifying the operation data 140, without having to modify the main program 130.

When the program 130 finds matching lines it stores the status in its data structures. Upon reaching the end of each file, the program calculates a similarity statistic by dividing the number of copied lines by the total number of lines in file B (at step 3120, FIG. 3A). If desired step 3218 executes the output reports flow chart.

FIG. 3D starts at entry point 3400 and continues along path 3402 to an append statistics line to statistics file 3404 step, where the calculated statistics are added to the end of a statistics log 452 (FIG. 4). Flow continues along path 3406 to an open output files 3408 where the desired output files are opened. Flow continues along path 3410 to an output formatted headers 3412 step, where the header information for the formatted report 150 is written out. In a currently preferred embodiment, the formatted report 150 is in Rich Text Format (RTF), and the header information contains the page size and layout, custom styles, text colors, and other information such as header and footer information.

Flow continues along path 3414 to an output formatted file A body 3416 step, where the lines from file A are formatted with the necessary highlighting to show the status of line (i.e. copied, obscured, or filtered) and with the necessary spacing to align the matching lines. This is also where the line wrapping indicators are output. Flow continues along path 3418 to an output formatted file B body 3420 step, which formats, wraps, and aligns the lines from file B in a similar manner. Flow continues along path 3422 to an output compare statistics 3424 step, where the statistics section 2430, translations found 2450, and other notes 2460 are output. At this point other output files shown in FIG. 4 are output along path 468. Flow continues along path 342 to a close files 3428 step, where the formatted report 150 and other output files (FIG. 4) are closed. Flow continues along path 3430 to a finish 3432 exit point.

### Line Wrapping

As discussed above, a novel feature of the present invention is the ability to wrap certain long lines and still maintain the proper side-side-by side alignment. As discussed above it is important the judge and jury be able to see the corresponding sections of code lined up side-by-side. Further, the file compare program 130 compares the tokens of a line from file A against a line from file B before formatting. Because a translation equivalent may be longer than the original word, the copied and translated line may be longer than the original line (for examples, see line 13 of FIG. 2B and FIG. 2D-1 and line 22 of FIG. 5B and FIG. 5G-1). It is also possible that the original line is longer than the translated line. It is important the judge and jury be able to see both lines in their entirety so that they can confirm the expert's work. At the same time it is important to line up subsequent corresponding line, and to mark each line (and continuation line) with the appropriate indications of copied, obscured, and filtered. Further, the file compare program 130 makes these determinations prior to formatting the report.

This feature may be implemented by maintaining data structures that keep track of the status of each line (i.e. copied, obscured, filtered or unknown) and the number of blank lines to be inserted between blocks of copied code to provide line-by-line alignment. The data structures are filled in and used during the compare files step 3116 (FIG. 3A), as detailed in FIG. 3B. Later, during the output reports step 3128 (FIG. 3A) as detailed in FIG. 3D, these data structures are used or adjusted during the formatting of the lines of each file so that the appropriate number of blank lines are output when the corresponding line in the other file is wrapped.

### Advanced System

FIG. 4 shows an advanced alternate system (alternate file compare system 400). FIG. 4 shows elements that may occur in various embodiments of the invention. This embodiment of the invention includes several advanced features including other operation data 140. File A 110, file B 120, the formatted report 150, are substantially the same as already described in reference to FIG. 1. Alternate file compare 430 is an embodiment of the file compare program 130, which supports the advanced features.

Unlike the translation equivalents 442 which is best maintained externally in a file, some of the other operation data 140 could be incorporated into the program. For example, the language keywords do not change from one project to another and could be built into the program. FIG. 4 shows a number of specific operational data files 440, including discovered translations 442, suspected translations 444, exclusions 446, obscured lines 448, language specific controls 470, and language keywords 472. Each of these is accessed along the operational data read path 464.

This embodiment of the discovered translations file 442 is similar to the discovered translations list 2300 shown in FIG. 2C, but provides support of multiple translations for the same word. For example, as shown in FIG. 5C “tries” can be translated as either lower case “attempts” or capitalized “Attempts” (see rows 5330 and 5332). This invention also anticipates the use of expressions in a discovered translation file that could be used to match similar changes applied to many words, such as adding or changing a common prefix for example, “num” to “number” (see row 5338) or a component identifier such a “MCP” to “MVP”.

As discussed above in relations to the token match tests (3330, 3350, and 3368 of FIG. 3C), the invention has the ability to output new possible translations 454. The user can analyze the output of a previous run to determine if there are some new possible matches that should be considered. These can be placed in a suspected translations file 444 which is used along with the discovered translations 442 in a trial run against a large set of files. The statistics of the run can be compared to previous statistics (in the statistics 452 log file) to see how the inclusion of the suspected translations 444 affected the results. True matches will typically be seen as an increase in statistics of several files. Once the expert verifies that a suspected translation is a true translation, the data can easily be moved to the discovered translations file 442 because both files are preferably in the same format. The format of a suspected translations 444 file is shown in FIG. 5D. Keeping the discovered translations 442 separate from the suspected translations 444 helps the expert avoid mixing educated guesses with verified opinions. In a large case, the number of translations can be in the thousands; this invention provides a novel method of testing suspicions without actually changing the verified discovered translation data.

As discussed above in relation to the tokenizing in reference to FIG. 3C, another specialized operational data file is the exclusions 446 file (see FIG. 5E and its more detailed discussion below).

As discussed above in relation to sophisticated techniques used to avoid detection, some changes cannot be shown by a token for token correspondence, such as, for example, when carriage returns are placed in what was one line of code to split it into three lines. When this happens, the present invention provides a way for those lines to be marked as obscured and automatically included in the statistics. To support this, an embodiment of the invention can include another specialized operational data file called an obscured lines 448 file (see FIG. 5F and its more detailed discussion below).

As discussed above in relation to sophisticated techniques used to avoid detection, one effective technique is to translate (or port) the copied work into another programming language. For example, if the original work was written in C, translate the program into Visual Basic. In order to effectively compare the two translated files, special rules for tokenizing or other processing may be necessary. One or more language specific 470 files may be used by embodiments of the invention to provide different handling for different languages. A specific example of such a file would be a language keyword 472 file for each major language. These files could be used to automatically determine the language of file A and B, and to select the appropriate set of specialized tokenizing rules. The language keyword 472 files could also be used to filter the translations used 456 file to result in an improved filtered translations 458 report. Depending on the context, an expert could be challenged for using common words like “if”, “else”, “open”, and “write” in a list of translated tokens.

Another specialized operational data file is a filter data file (not shown). The filter data file could have the same format as the discovered translation file. It can be used to automatically filter lines that match using discovered translations that are included in the filter data file. This is useful when both sets of files use the same common public domain libraries or headers. The code has been copied, but the court needs to be able to identify which lines were legally copied. This filtering would occur in the token match tests (3330, 3350, and 3368 of FIG. 3C) where the tokens lines would be marked as copied, but if the match was based on a discovered translation the line would be marked as filtered. This allows the court to see where a block of code was copied where some of it was permissively copied and other aspects of the copied block were not defensible. It is arguable that the illicit copier should be charged for the otherwise filterable lines because the evidence shows that it was copied as a block in combination with the illicit copying. In an embodiment of the file compare program 130, the matched but filtered tokens can be stored in a data structure and then output to a filtered translation 458 file.

As already discussed in various sections above, the advanced system also produces a number of output files in addition to the formatted report 150. These may include a statistics 452 log, new possible translations 454, a list of translations used 456, and filtered translations 458 (that should be filtered under courts guidelines). These are output along the additional output path 468.

As discussed above, many of the advanced features are specified using the advanced user interface options 480 (which is an advanced version of user interface options 180 of FIG. 1), which are accessed along UI path 482 (similar to 182 of FIG. 1).

### Files Showing Examples of More Sophisticated Techniques

FIGS. 5A and 5B shows alternate example files. FIG. 5A shows a file named jumpVerify.c. FIG. 5B shows a file named leapConfirm.pl. This is an example where the original file was written in one language, C, and the copied code has been translated to another language, Perl. Again, at first glance, these two files appear to have no similarity, but the invention will automatically show that a significant portion of the file was literally translated.

### Operational Data

FIG. 5C shows another example of discovered translation data, alternate discovered translations 5300. Line 11 5330 and line 12 5332 show an example of multiple translation for the same word, as discussed above.

FIG. 5D shows an example of suspected translation data, suspected translations 5400. Line 1 5410 shows a first suspected original word 5410a, and a first suspected translation equivalent 5410b.

FIG. 5E shows an example of exclusions list 5500 data. The expressions 5500a are shown on the left and the comments 5500b are shown on the right. A first expression 5510a is an example of a Perl expression that will be used by the file compare program 130 or 430 to exclude certain information from each line. In this case, the comment “//MvP” will be ignored on each line. In the context of these two files, this comment was added by the illicit copier to avoid detection by traditional file compare programs like diff. As indicated by the first comment 5510b, the expression limits the exclusion to only where the comment appears as the last set of tokens on a line. This is an example of rule that would only be applied in a specific project. Without this rule the program would not be able to automatically show the true extent of the illicit copying. Line 2 5512 shows a second expression 5512a and a second comment 5512b. This exclusion would ignore hiatus words. Perl does not use types, so there is no need to specify the data type “int” for integer. However those skilled in the art would know that the Perl program performs the same function as the C program even without the words that specify type. Other expressions can be used to include line numbers as discussed above in relation to FIG. 3C.

FIG. 5F shows an example of obscured lines list 5600 data. The data is represented in five columns:

start A 5600a the starting offset for an obscured block of file A

block A 5600b the length of the block for an obscured block of file A

start B 5600c the starting offset for a corresponding obscured block of file B

block B 5600d the length of the corresponding block of file B

file 5600e the file name of the file to apply the obscured highlighting

Line 1 5610 gives the following example, the first block of file A starts at line 17 (5610a) and should be marked obscured for I line (5610b). The corresponding block in file B starts on line 18 (5610c) and also goes for one line (5610d). The file name (5610e) where these obscured lines have been found is “Exhibit 5D”. Note that on the second line (5612) the blocks start on lines 20 and 21, respectively and unlike the first example the blocks have different sizes, 5 and 2 respectively. The effects of this data file can be seen in FIG. 5G-1. Note that the constructs used in the “Verify jump” loop and the if statement and print statement are so different that the indicated lines arguable are not literally copied or translated, and yet the essence of the original program has been copied and in fact would produce the same results using equivalent programming logic and constructs. The obscured lines list 5600 data directs the file compare program 130 or 430 to mark the copied and obscured lines and automatically includes them in the statistics for the file.

### Advanced Output

FIG. 5G shows another example two page exhibit identifying detection of more sophisticated copying techniques. The format of FIG. 5G is similar to FIG. 2D. The exhibit name 2400, body of file A 2400a, body of file B 2400b, confidentiality legend 2402, footer name 2404, page information 2406, file A pathname 2408, file B pathname 2410, separator bar 2420, statistics section 2430, total lines statistics 2432, copied lines statistics 2434, obscured lines statistics 2436, filtered lines statistics 2438, translation comment 2440, translations found 2450, notes 2460 are all analogous to the same elements as described in reference to FIG. 2D.

The differences in FIG. 5G are in the file pathnames (2408 and 2410, respectively), the exhibit names (2400), the footer names (2404), the statistics values (2432, 2434, 2436, 2438) in the statistics section (2430), the translations found (2450), and the contents of the files and how the file compare program 130 or 430 has been able to detect and highlight the similarities in spite of the more sophisticated techniques employed.

The embodiment that produced this exhibit supported the features of the discovered translations 5300 as shown in FIG. 5C as shown on line 3 of both files (showing, for example, a match on “tries” and “attempts” from line 5330) and lines 14 and 15, respectively (showing a match on “tries” and “Attempts” from line 5332), as well as others.

The embodiment that produced this exhibit also supported the features of the suspected translations 5400 as shown in FIG. 5D as shown on lines 16 and 17, respectively (showing, for example, a match on “Verify” and “Confirm” from line 5410, as well as others). Once the user reviews the output as shown in FIG. 5G, the suspected translations 5400 are both confirmed as valid. The data can then be moved from the suspected translations 444 file to the discovered translations 442 file.

The embodiment that produced this exhibit also supported the features of the exclusions words and exclusion expressions, collectively exclusions list 5500, as shown in FIG. 5E as shown on lines 9 through 13 of file B (showing the meaningless “//MvP16” comment being excluded in determining otherwise literal translations) and lines 4, 6 and 7 of both files (showing, for example, the hiatus rule regarding the no longer needed “int” language keyword). Note on page two (FIG. 5G-2) a full disclosure is made regarding the excluded (ignored) tokens by showing the applicable comments from the exclusions list 5500, in particular the comments 5500b from Exhibit 5E at 5774 and 5772, respectively. An exclusion note introduces and precedes the comment list at 5768. Collectively, all exclusion comments used 5770 are listed.

Further the lines specified by the obscured lines data list 5600 were automatically marked and included in the statistics as explained earlier in reference to FIG. 5F.

FIG. 5G also shows a good example of how blank lines are inserted into the formatted exhibit to line of the matching lines. Note that the last lines of the files are the same, but, because the C construct on the left (lines 22-25) was longer than the Perl construct on the right (line 22), it was necessary to insert blanks lines before line 23 on the right. Line 22 on the right also shows a case where there is line wrapping.

What has not been shown in these simple examples are examples where the same block of code has been copied multiple times or where the code has been re-arranged. However the process that provides for features has been explained in reference to the flow charts of FIG. 3A through FIG. 3D.

In this example, the formatted report demonstrates that for all intents and purposes the entire substance of the original work has been illicitly copied. A diff-like program would have failed to detect and show any substantial similarities.

### Bulk Compare

As described thus far the file compare system (100 or 400) is an effective way to automatically detect, highlight, and account for the illicit copying found in a pair of files, where one was at least in part copied from another. The user though must be able to select the right pair of files to compare. When there are tens of thousands of files in each set of files, the original set of files and the alleged infringing set of files, this is still an expensive and time consuming task. The present invention makes use of the file compare system (100 or 400) to automatically detect any files that have similarity even with having first developed a full “Rosetta Stone” (i.e. a complete discovered translations 442 file). Further invention provides an automated way to start the development of the needed discovered translations.

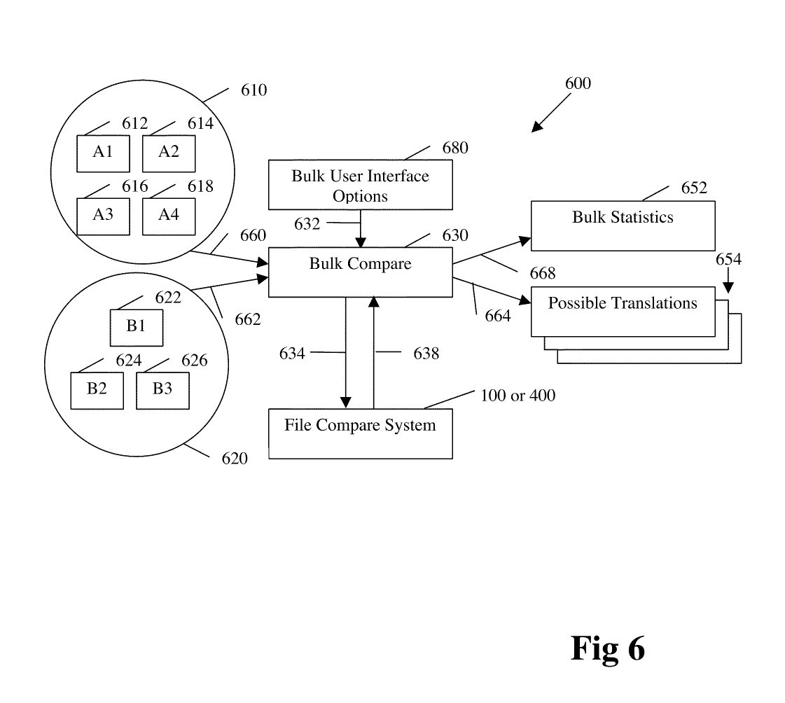

FIG. 6 illustrates an example of a bulk compare system 600. In this example, the original set of files, file set A 610, is represented by a hypothetically small number of files (four):
file A1 612
file A2 614
file A3 616
file A4 618
   The allegedly infringing set of files, file set B 620, is also represented by a hypothetically small number of files (three):
file B1 622
file B2 624
file B3 626

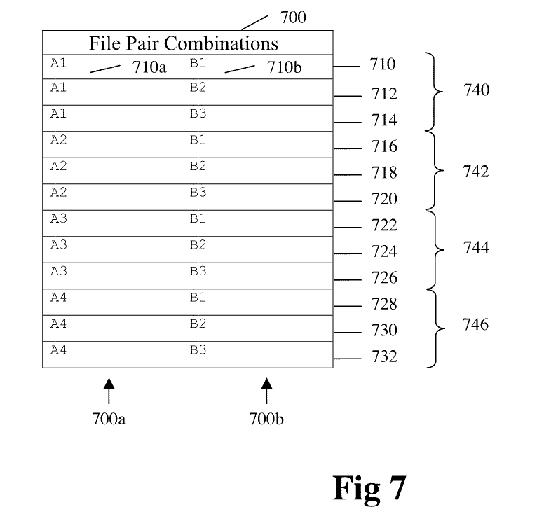

FIG. 6 is also a bulk compare program 630 which reads the names of the files in file set A 610 along path 660 and reads the names of the files in file set B 620 along path 662. After obtaining all of the file names the bulk compare program 630, generates a list of every combination of files. In this example, there are only twelve combinations as shown in FIG. 7, but in a real project there may be millions of combinations (e.g. 10,000×12,000=120 million). The bulk user interface options 680 can be used to limit the number of combinations generated by limiting, at least at first, the combinations to certain types of files, for example, C source and header files from file set A could only be paired with C++ source and headers from file set B. Certain file types could be excluded, for example Microsoft Word *.doc files or build files (e.g. *.mak, *.dsw, *.dsp) files.

Once the file pair combinations (see 700 in FIG. 7) have been generated as directed by the bulk user interface options 680 through the bulk user interface 632, the bulk compare program 630 executes the file compare system (either 100 or 400 as previously described) to process each pair of files as respectively file A 110 and file B 120. In one embodiment of the bulk compare system 600, each invocation of the file compare system (100 or 400) is made by supplying user interface options via path 634 and the results are returned via path 638. In an alternate embodiment, the bulk compare program 630 could be implemented as an integrated combination with the file compare system (100 or 400) where the bulk compare program would be combined with the file compare program (130 or 430). In yet another embodiment the bulk compare program 630 simply generates a script with the appropriate user interface options specified on each line and when the user executes the script, the file compare system (100 or 400) is executed repeatedly.

Regardless of the specific implementation details, each embodiment of the logs the statistics of each combination in a version of the statistics log file 452, shown here as bulk statistics 652 and the possible translations 654 is a group of new possible translations 454 from each file pair combination. The real value of the similarity threshold (see above regarding similarity threshold decision 3212 in FIG. 3A) feature can be understood in this mode of operation. Because each pair is sequentially generated, only one out of 12,000 combinations may actually be a valid pairing. Because this type of processing can take days even on fast computers, it is important the time taken with an invalid pair be minimized. The similarity threshold feature allows for non-matching files to be skipped saving both the processing time and the storage space for the worthless side-by-side report exhibits. On the pairs with high statistics are preserved. The threshold can be varied based on the overall similarity of the respective files sets. Typically, without a good set of discovered translations, a similarity of even 1% can be an indication that the files are a matched pair and had help determine the first few discovered translation entries. The possible translations 654 for the pairs yielding high percentages can be mined for valid translations. Further by examining the files with the highest similarity, rules can be developed to filter certain tokens or exclude meaningless difference.

FIG. 7 shows an example of file pair combinations 700 base one the example file sets shown in FIG. 6. The first row 710 shows the pair for file A1 (710a) and the file B1 (710b), collectively the A1-B1 pair 710. The remaining pairs are:
A1-B2 pair 712
A1-B3 pair 714
A2-B1 pair 720
A2-B2 pair 722
A2-B3 pair 724
A3-B1 pair 730
A3-B2 pair 732
A3-B3 pair 734
A4-B1 pair 740
A4-B2 pair 742
A4-B3 pair 744
A4-B3 pair 746

Note that file A1 612 is paired first paired with each file in file set B 620, i.e. file B1 622, then file B2 624, and the finally file B3 626, as shown in the first three rows of FIG. 7 (740), before moving on to the pairs with file A2 (742), A3 (744), and A4 (746), respectively. This shows the value of reading file A into memory and keeping it until all the processing is done (as discussed above in reference to step 3104 in FIG. 3A). In this bulk mode of operation, file A1 is kept in memory and compared against all of the other files it is paired with before it is released. In a real project with tens of thousands of files, this same hours or days of relative slow file input.

Another novel feature of the present invention is that in bulk mode, the bulk compare system can generate meaning names for the millions of potential output files. The names can be a unique combination of the files pairs, the resulting statistics, and optionally other elements. This allows the files to be sorted using the conventional directory viewing feature of an operating system.

### Overall Process

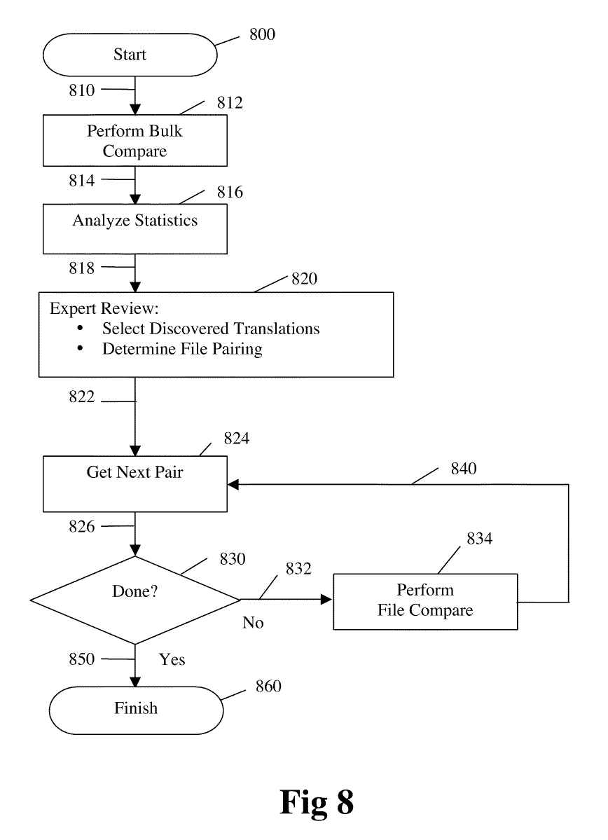

Now that the individual elements have been described, the overall process of using the invention will be described in reference to FIG. 8. Ultimately the user, a computer science forensic expert preferred embodiment, is responsible for the accuracy of the results of the system. The overall process must in some manually review to ensure the accuracy and validity of the otherwise automated results.

FIG. 8 shows an overall process including expert review. The process starts at entry point 800. At this point the expert has possession of tens of thousands of files but because of the sophisticated levels of translated and obscured copying, has little or no discovered translations (2300 or 5300).

The expert selects bulk user interface options at 810 to initiate the bulk compare 812 step. At step 812, the bulk compare program generates file pair combinations 700 as directed and explained above in reference to FIG. 6 and FIG. 7. The system then analyzes the statistics at step 816 and presents the highest statistics to the expert for review at step 820. The human user, the expert, reviews the bulk-generated statistics 652, the possible translations 654, and the formatted reports (150 or 450) for the high similarity pairs. At this point 820 the user places valid translations in the discovered translation 442 file and selects a group of valid pairs to be run again. These file pairings could be recorded in a script file or an operational data file that drives file compare system (100 or 400) in a loop comprised of a get next pair 824 step, done decision 830, and perform file compare 834 step. The results of this run should result in higher statistics and improved new possible translations 454 for each file pair. The expert can continue to repeat steps 816, 820, and 834 until the results are optimal.

It should be understood that during these iterative steps, the various operational data files and user interface options can be fine-tuned to show the high degree of actual copying. Ultimately the human user is responsible for the proper filtering and marking of obscured lines that the automated process is unable to show. The final feature of the invention is an automated way to generate accurate statistics for even the highlighting that is performed by the human user in the final review.

### Reformatting and Automatic Statistics Updating

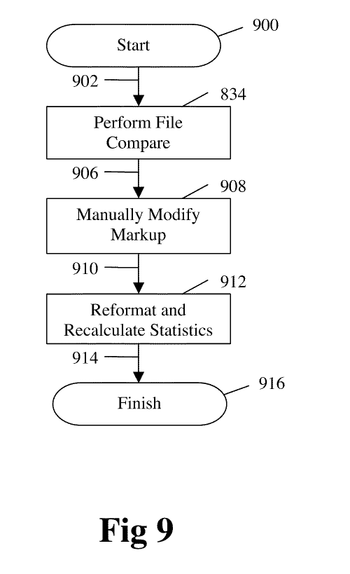

FIG. 9 shows a process for reformatting and recalculating statistics following expert review and adjusted marking. When the formatted reports 150 are generated, the statistics and status of each line are stored in the file. The original file paths and other user interface options are stored as meta-data in the file. A novel aspect of this invention is the ability to extract the statistics, status information, and meta-data from the report files 150 and automatically update the statistics based on manually edited highlighting.

The process for each file is represented in the flow chart of FIG. 9. The process starts at entry point 900. First the automated file compare system is used to create a report at 834. Next the user manually modifies the marking to show additional filtering and/or obscured copying at 908. Finally the file compare program 130 or 430 is run with a user interface options that does not perform a new comparison but uses the stored meta-data to reformat the report and recalculate the statistics. The updated statistics are shown in the file in the statistics section 2430 and in an updated statistics 452 log. This mode of operation can also generate an updated obscured lines 448 files.

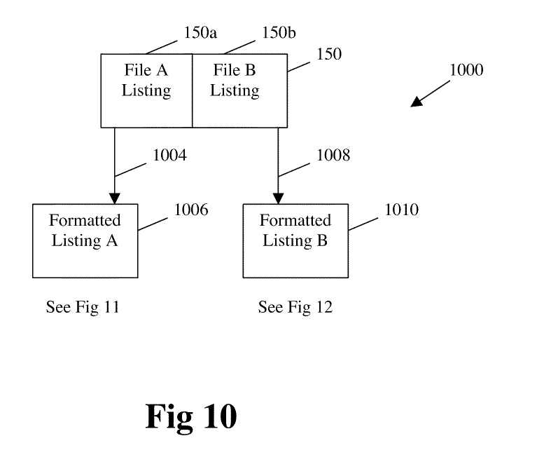

### FIG. 10

FIG. 10 shows a process of statistics update and separate file formatting. In this exemplary embodiment, the process of statistics update and separate file formatting 1000, parses formatted report 150 and outputs two individual formatted reports, Formatted Listing A 1006 and Formatted Listing B 1010, respectively. The parsing step extracts the formats from both File A Listing 150a and File B Listing 150b that comprise the left and right columns of Formatted Report 150, respectively. Once extracted, these formats are applied and output to Formatted Listing A 1006 and Formatted Listing B 1010, respectively. The file output paths are represented by 1004 and 1008, respectively. In a currently preferred embodiment, the formatted reports 1006 and 1010 are in Rich Text Format (RTF), and the header information contains the page size and layout, custom styles, text colors, and other information such as header and footer information.

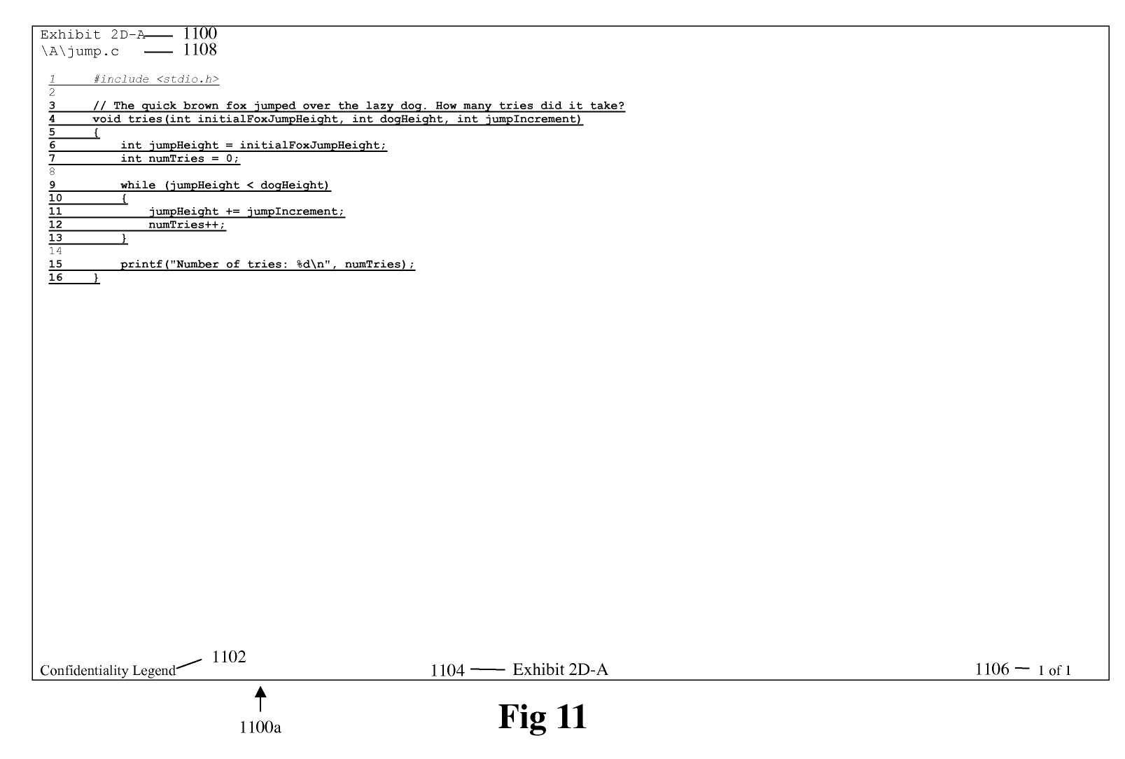

### FIG. 11

FIG. 11 shows an exemplary Formatted Listing A 1006, entitled Exhibit 2D-A, which contains a formatted listing from the exemplary file A of FIG. 2A.

The format of FIG. 11 is similar to FIG. 2D. The listing exhibit name 1100, listing body of file 1100a, listing confidentiality legend 1102, listing footer name 1104, listing page information 1106, and listing file pathname 1108 are all analogous to elements 2400, 2400a, 2402, 2404, 2406 and 2408, respectively, as described in reference to FIG. 2D.

The differences in FIG. 11 are in the exhibit names (1100), the footer names (1104) and the contents of the body of file (1100a). In addition, FIG. 11 displays the contents of only one file in the body of the listing report as it contains only information from the left hand column.

The content of FIG. 11 is produced by the statistics update and separate file formatting 1000 method using the exemplary file Exhibit 2D as input (see FIG. 2D-1 and FIG. 2D-2). In these exhibits, lines of code that have been literally copied or translated are shown in red and are underlined (for example, see line 3). Lines of code that are not literally identical, but are technically equivalent due to insubstantial differences are shown in blue and are underlined (see FIG. 5G for an example). Lines that were copied but have been filtered are shown in magenta and are underlined in italics (for example, see line 1). The use of underline and italics allow for black and white copies to be useful even though the full color exhibits will be used in the courtroom.

The body of the Formatted Listing A 1100a contains the lines from file A (FIG. 2A) formatted the way they appear in file A in 2400a. Note that the line formats for each line match exactly those found in 2400a with the exception of any blank lines inserted for alignment purposes between file A 2400a and file B 2400b.

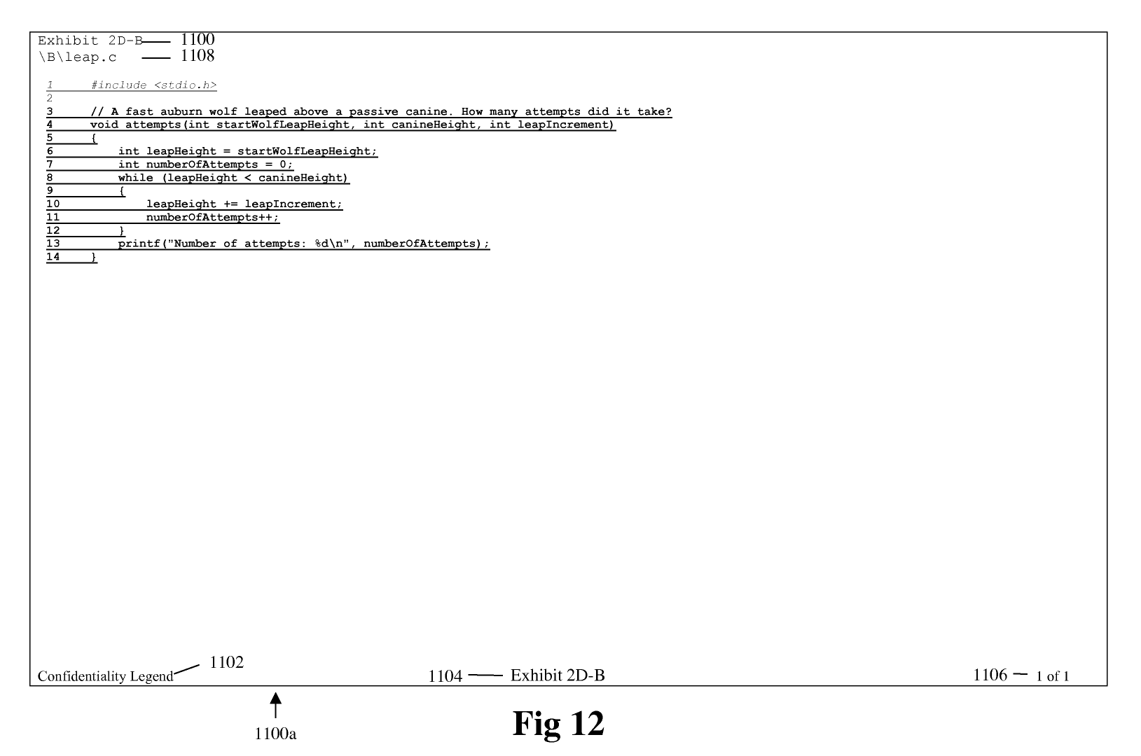

### FIG. 12

FIG. 12 shows an exemplary Formatted Listing B 1010, entitled Exhibit 2D-B, which contains a formatted listing from the exemplary file B of FIG. 2B.

The format of FIG. 12 is similar to FIG. 11. The listing exhibit name 1100, listing body of file A 1100a, listing confidentiality legend 1102, listing footer name 1104, listing page information 1106, and listing file pathname 1108 are all analogous to the same elements as described in reference to FIG. 11.

The differences in FIG. 12 are in the exhibit names (1100), the footer names (1104) the pathname names (1108), and the contents of the body of file (1100a). FIG. 12 displays the contents from only one file, the right hand column from FIG. 2D.

The content of FIG. 12 is produced by the statistics update and separate file formatting 1000 method using the exemplary file Exhibit 2D as input (see FIG. 2D-1 and FIG. 2D-2). In these exhibits, lines of code that have been literally copied or translated are shown in red and are underlined (for example, see line 3). Lines of code that are not literally identical, but are technically equivalent due to insubstantial differences are shown in blue and are underlined (see FIG. 5G for an example). Lines that were copied but have been filtered are shown in magenta and are underlined in italics (for example, see line 1). The use of underline and italics allow for black and white copies to be useful even though the full color exhibits will be used in the courtroom.

The body of the Formatted Listing B 1100a contains the lines from file B (FIG. 2B) formatted the way they appear in file B in 2400b. Note that the line formats for each line match exactly those found in 2400b with the exception of any blank lines inserted for alignment purposes between file A 2400a and file B 2400b.

### Statistics Update and Separate File Formatting

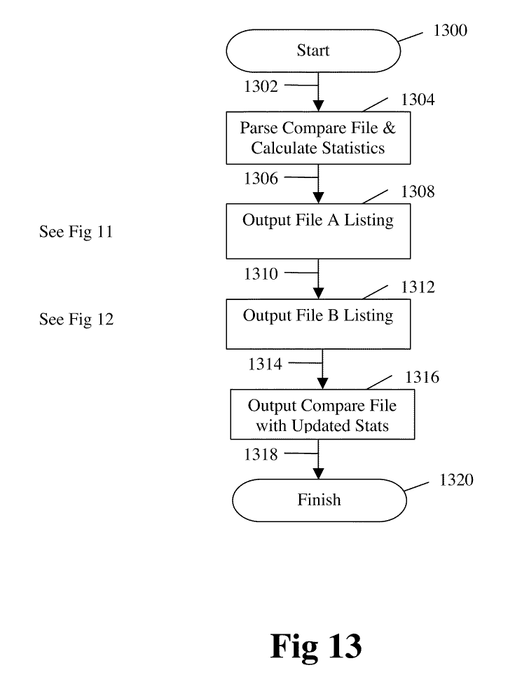

FIG. 13 shows a process for statistics update and separate file formatting 1000 following expert review and adjusted marking. When the formatted reports 150 are generated, the statistics and status of each line are stored in the file. The original file paths and other user interface options are stored as meta-data in the file. A novel aspect of this invention is the ability to extract the statistics, status information, and meta-data from the report files 150 and automatically update the statistics based on manually edited highlighting. The meta-data describes data objects that are stored in the file, but are not normally displayed, e.g. custom document properties.

The process is represented in the flow chart of FIG. 13. The process starts at entry point 1300. Flow continues along path 1302 to first parse a report file 150 and recalculate statistics 1304. The statistics are recalculated based on the formatted lines as parsed after manual updating of the formatting (for example additional filtering).

Flow continues along path 1306 to an Output File A Listing step, where the Formatted Listing A 1006 is output. In a currently preferred embodiment, the formatted listing 1006 is in Rich Text Format (RTF), and the header information contains the page size and layout, custom styles, text colors, and other information such as header and footer information.

Flow continues along path 1310 to an Output File B Listing step, where the Formatted Listing B 1010 is output. In a currently preferred embodiment, the formatted listing 1010 is in Rich Text Format (RTF), and the header information contains the page size and layout, custom styles, text colors, and other information such as header and footer information.

Flow continues along path 1314 to an Output Compare File with Updated Stats step, where a version of report file 150 with updated statistics is output. The updated statistics are shown in the file in the statistics section 2430 and in an updated statistics 452 log. This mode of operation can also generate updated obscured lines 448 files.

Flow continues along path 1318 to a finish 1320 exit point.

The output steps could be done in any order after the report file is parsed and the statistics are updated, thus after step 1304 the order of the remaining steps in not significant. Further, if only the A side or only the B side is desired, the unneeded step could be omitted.

### Other Features

Other features and advantages, not specifically detailed will be apparent to one of skill in the art upon reading this disclosure.

### Advantages

### Rapid Analysis

The present invention provides a system that can rapidly analyze large sets of files to determine similarity.

### Reduced Cost

The present invention reduces the cost of detecting and present illicit copying by providing many automated features as described above.

### Performance

The present invention has many novel features that enhance performance.

### Scalable

The present invention allows for processing of tens of thousands of files and millions of lines of code, while working effectively on a single pair of files.

### Robust Feature Set

The present invention provides a set of default features that can be easily customized to meet special needs, without modifying the main program(s).

### Consistent Presentation

The present invention facilitates a consistent look for its exhibits. The presentation provides full disclosure of steps taken to produce the exhibits.

### Automatic Update of Statistics and Listings

The present invention accommodates manual expert review and automatically updates statistics and formatting, of side-by-side and individual listings, following manual edits to documents.

### Advantages Achieved by the Present Invention

The present invention achieves a long list of objectives as disclosed herein, including the following:
1. To reduce the cost of analyzing files in a copyright or trade secret lawsuit
2. To automatically find and mark literal copying
3. To automatically find and mark literal translation
4. To automatically filter material that should be filtered
5. To automatically identify copied material that has been filtered
6. To automatically calculate statistics on total lines, lines copied, lines obscured, lines filtered, and percentages
7. To automatically identify and confirm translations that have been used
8. To automatically identify copying even when the code was translated from one programming language to another
9. To automatically identify copying even when words and comments that didn't change the essential function of the code
10. To provide a mechanism to automatically identify copying even when the carriage returns were added
11. To automatically identify copying even when sections files have been rearranged (both within a file and between files)
12. To identify information that has been copied more than once
13. To automatically provide a mechanism to exclude portions of each line prior to comparing the more meaning portions (e.g. exclude unique number of each line)
14. To automatically determine which pairs of files should be compared
15. To automatically skip pairs of files that have no little or no similarity so that those that do have similarity can be presented sooner and with fewer resources
16. To automatically identify possible translations that might not yet have become known (or discovered)
17. To automatically apply customized rules base on observed technique for obscuring copying
18. To automatically provide an easy to use method of customizing the rules and translation used for each project without modifying the program
19. To provide a method of dynamically loading a discovered translations table for each file comparison, which can be modified and stored separately for each group of appropriate files
20. To provide a method of dynamically loading a suspected translations table for each file comparison, which can be modified and stored separately for each group of appropriate files, whereby suspected translations can be identified and verified for later inclusion as discovered translations for future runs
21. To provide a method of detection for similarities in comments which utilize different comment syntax
22. To provide a threshold that limits usage of computer processing and storage resources on compares yielding little or no similarity, by aborting or reducing processing and avoiding formatted report generation.
23. To provide output file names which are meaningful to facilitate rapid review of highly similar files
24. To provide a system that will run on multiple computer platforms with different file naming conventions.
25. To provide a system that will determine file subsets for batch comparisons based on user selectable criteria.
26. To provide a system that will determine file subsets for batch comparisons based directory structure.
27. To provide for multiple translations of the same word in different file pairs.
28. To provide a system that efficiently processes batch comparisons by reusing information previously obtained for one or both files in the pair.
29. To increase the accuracy of the reports.
30. To provide a common look for all forensic exhibits.
31. To provide forensic exhibits that can be read on a wide variety of platforms and by a wide variety of users.
32. To provide user selectable output sizes (e.g. letter and legal sized paper) and layouts (e.g. portrait or landscape) with maximum use of page space while maintaining readability.
33. To provide full disclosure of specialized rules, forensic methods, and evidence modifications.
34. To provide full data for each line, without truncation, while still maintaining proper alignment of matching lines.
35. To provide a way to identify meaningful tokens from different programming languages using language specific control and data.
36. To apply language specific options based on automatic language detection.
37. To provide a report of translations detected that have language keywords and other non-illicit language filtered.
38. After producing a side-by-side listing marked to show copied, obscured, and filtered between two files, to produce an identically marked listing of each of the two files separately.

### CONCLUSION, RAMIFICATION, AND SCOPE

Accordingly, the reader will see that the present invention provides a system that that will automatically compare sets of files to determine what has been copied even when sophisticated techniques for hiding or obscuring the copying have been employed.

While the above descriptions contain several specifics these should not be construed as limitations on the scope of the invention, but rather as examples of some of the currently preferred embodiments thereof. Many other variations are possible. For example, the system is not limited to detection of copying of computer source code but can be used to determine translated similarity in many kinds of documents and data files. Further, the use this invention is not limited to court cases, this invention provides valuable insight regarding how software has changed. Software developers and managers may use the invention to better understand their own software or documentation and how those assets have evolved.

Accordingly, the scope of the invention should be determined not by the embodiments illustrated, but by the appended claims and their legal equivalents.

We claim:

1. A system for comparing sets of files to determine instances of obscured copying, comprising:
at least one translation file having translation data including original words and corresponding translation equivalents, the translation file prepared by a user, the user identifying translation equivalents that are discovered by the user to be used to obscure copying of the original words,
a user interface for specifying at least one user interface option, and
a file compare program having executable instructions for comparing a first file to a second file in accord with the user interface options and the translation data to thereby detect obscured copying, and for producing a formatted report that lists obscured copied material.

2. The system of claim 1, wherein the file compare program parses the first file into a first set of tokens and the second file into a second set of tokens, and wherein the file compare program parses the translations file to obtain matched pairs, each matched pair comprising:
an original data word token, and
a translation equivalent token,
wherein the file compare program:
i) selects each token from the first set of tokens, a first current token, and sequentially selects each token from the second set of tokens, each token from the second set of tokens sequentially being a second current token,
ii) compares the first current token to the second current token to determine if there is an exact match,
iii) if there is not an exact match, compares the first current token to each original data word token to selected a current matched pair, and compares the translation equivalent token of the current matched pair to the second current token to determine if there is an translated match,
iv) if there is a translated match, selects the next token from the first set of tokens as the first current token and selects the next token from the second set of tokens as the second current token,
v) continues steps (ii) through (iv) until a sequence of matching tokens has been found, and
vi) marking a first group of matching tokens from the first set of tokens and second group of matching tokens from the second set of tokens, based on the sequence of matching tokens, as identified copying,
wherein groups of matching tokens are marked,
wherein at least some groups of matching tokens are aligned, and
whereby the formatted report highlights groups of matching tokens that include translated matches.

3. The system of claim 2, wherein the sets of tokens are compared on a line by line basis and groups of matching tokens are identified with at least one line, being a matched line.

4. The system of claim 3, wherein after one or more matched lines are identified, the file compare program looks back to identify matched lines that are out of order.

5. The system of claim 2, wherein the file compare program keeps track of the matched pairs of that were used to determine translated matches and includes the list of translations found in the formatted report.

6. The system of claim 2, wherein the file compare program keeps track of the matched pairs that were used to determine translated matches and includes in the formatted report statistics regarding the total lines copied and the total lines obscured.

7. The system of claim 1, wherein the user interface options specify a format for the formatted report from a plurality of format options, including size or layout.

8. The system of claim 1, wherein the first file and the second file comprise a first set of files, the system further comprising:
a second set of files, comprising a third file and a fourth file, and
a plurality of discovered translation files each including a different set of original words and corresponding translation equivalents that are discovered and identified by the user as words used to obscure copying,
wherein the user interface options specify a first discovered translation file from the plurality of discovered translation files to be used when comparing the first set of files, and a second discovered translation file from the plurality of discovered translation files to be used when comparing the second set of files,
whereby the first set of files is compared using the first discovered translation file and the second set of files is compared using the second discovered translation file.

9. The system of claim 1, wherein the formatted report contains line numbers showing the original position in the first file and second file respectively, and wherein the blank lines have no line numbers.

10. The system of claim 1, wherein long lines in the formatted report are wrapped, and wherein the blank lines are inserted as needed to maintain alignment of sequences including wrapped lines, whereby full comparison of long lines is provided in a side-by-side listing.

11. The system of claim 1, further comprising operational data files which specify rules that improve the results of the file compare.

12. The system of claim 3, further comprising operational data files which specify rules that improve the results of the file compare, wherein the rules specify exclusion expressions that are used by the file compare program to ignore one or more tokens that have been inserted to defeat line to line comparisons.

13. The system of claim 1, further comprising operational data files which specify portions of the first file and corresponding portions of the second file to be marked as obscured matches, wherein a user can detected obscured copying that is not detected by the file compare program, and whereby the formatted report contains highlighting indicating obscured copying, whereby statistics regarding obscured copying are calculated and included in the formatted report.

14. The system of claim 1, wherein the file compare program outputs the statistics of each compare to a statistics file, and whereby the history of each compare is compared over time.

15. The system of claim 2, wherein after a sequence of tokens have matched, a subsequent token from the first file does not match the corresponding token from the second file, being a mismatched pair, wherein the file compare program outputs the mismatched pair as a possible translation, and whereby the user is notified of potential translation equivalents that have been used to obscure copying.

16. A bulk compare system for comparing collections of files, the bulk compare system comprising:
the file compare system of claim 1,
a first collection of files, each capable of being the first file compared by the file compare program,
a second collection of files, each capable of being the second file compared by the file compare system,
one or more bulk user interface options, and
a bulk compare program,
wherein the bulk compare program determines a number of file pairings between files in the first collection of files and the files in the second collection of files, wherein the file compare program compares each of the file pairings, wherein the bulk compare program keeps track of the statistics for each pairing as bulk statistics, wherein the pairings with the highest statistics in the bulk statistics indicate pairings that are likely to have been copied, whereby obscured copying is automatically detected between two collections of files.

17. The bulk compare system of claim 16, wherein the bulk compare program outputs a plurality of possible translations from each comparison, where the possible translations from the pairings with the highest statistics indicate likely translations, and whereby a user is notified of possible translations that will improve the level of detection of obscured copying.

18. A method of detecting obscured copying, comprising the steps of:
receiving at least one translation file prepared by a user, wherein the translation file includes a list of original words and corresponding translation equivalents, the translation equivalents being identified by the user as words used to obscure copying of the corresponding original words;
reading a first file;
reading a second file;
comparing the second file to the first file on a line by line basis;
marking the similarities between the first file and the second file in accord with literal similarities or obscured similarities based on the translation file;
calculating a set of statistics based on the marked similarities; and
outputting a report which shows and highlights the similarities between the files.

19. The method of claim 18, further comprising the steps of:
manually modifying the report output in the outputting step,
reformatting the report based on the manual modifications, and
recalculating the statistics to provide an updated set of statistics,
whereby automatically found similarities can be filtered or augmented while maintaining accurate formatting and statistics.

20. The method of claim 18, further comprising the steps of:
outputting a first individual listing showing the highlighting associated with the first file, or
outputting a second individual listing showing the highlighting associated with the second file,
whereby the similarities are shown in a listing of at least one of the files.

21. A method for detecting obscured copying, comprising:
receiving at least one discovered translations file from a user, the discovered translations file including a plurality of pairs of words, each pair having an original word correlated with a translation equivalent word by the user, wherein each translation equivalent word is discovered by the user to be used to obscure copying of the corresponding original word;
receiving a-selection of options from the user, including a selection of at least a first file and a second file to compare, a selection of operational data for the compare operation, said operational data including the at least one discovered translation file, and a selection of a similarity threshold for the compare operation;
reading the first and second file identified in the user selection;
reading the operational data identified in the user selection;
comparing the second file to the first file using the operational data and identifying each instance of obscured copying in the second file;
calculating a similarity value for the comparing step; and
if the similarity value exceeds the similarity threshold, then compiling and outputting a report which highlights suspected copying in the second file.

22. A tangible computer-readable medium having executable instructions for performing the method of claim 21.
